(19) United States
(12) Patent Application Publication
(10) Pub. No.: US 2007/0233585 A1
(43) Pub. Date: Oct. 4, 2007

(54) Device, system and method of interactive gaming and investing

(76) Inventors: Tal David Ben Simon, Tel-Aviv (IL); Tomer Pascal, Tel-Aviv (IL)

Correspondence Address: EMPK & SHILOH, LLP, 116 JOHN ST,, SUITE 1201, NEW YORK, NY, 10038, US

(21) Appl. No.: 11/717,120

(22) Filed: Mar. 13, 2007

Related U.S. Application Data
(60) Provisional application No. 60/781,701, filed on Mar. 14, 2006.

(51) Int. Cl. G06Q 40/00

(52) U.S. Cl. 705/35

(57) ABSTRACT

Device, system and method of interactive gaming and investing. For example, a system includes a computing platform to register for sale a stock, wherein the stock corresponds to a real-life sports player and wherein the stock is associated with a real-life price.

### PRIOR APPLICATION DATA

The present application claims priority and benefit from U.S. Provisional Patent Application Ser. No. 60/781,701, entitled “System and Methods for the Creation and Management of Real Money Driven, Online Stocks Exchange Market, Supporting Balanced Supply-Demand Rate, and Market Growth”, filed on Mar. 14, 2006, which is hereby incorporated by reference in its entirety.

### FIELD

Some embodiments of the invention are related to online investing systems and interactive gaming methods.

### BACKGROUND

A fantasy sport may include a game in which participants construct fantasy sports teams, for example, by assembling multiple sports players. For example, a participant may construct a fantasy soccer team by assigning a first soccer player to man a goalkeeper position, a second soccer player to man a striker position, or the like.

Fantasy sports teams may score fantasy points based on real-life performance of sports players. For example, if in a real-life soccer match the second soccer player scored a goal, then the fantasy team of the participant may receive five fantasy points, e.g., since the second soccer player is a part of the fantasy soccer team. Similarly, if in a real-life soccer match the first soccer player receives a yellow card, then three fantasy points may be deducted from the fantasy score of the fantasy soccer team, e.g., since the first soccer player is a part of the fantasy soccer team.

Some gaming systems may allow participants to build their fantasy sports teams, and may simulate a competition among those fantasy sports teams based on real-life performance of sports players.

### SUMMARY

Some embodiments of the invention may include, for example, devices, systems and methods of interactive gaming and investing.

Some embodiments may include, for example, a system including a computing platform to register for sale a stock corresponding to a real-life sports player and associated with a real-life price.

In some embodiments, the computing platform is operably associated with a database able to store information regarding ownership of shares of the stock.

In some embodiments, the computing platform includes a trading interface to transfer one or more shares of the stock from a first user of the system to a second user of the system, and to transfer a price of the one or more shares from an account of the first user to an account of the second user.

In some embodiments, the trading interface is to update the database to reflect change of ownership of the one or more shares from the first user to the second user.

In some embodiments, the computing platform is to detect that a market demand for the stock is greater than a market supply of the stock, to determine that a market failure exists, and to register for sale new shares of the stock based on a difference calculated between the market demand and the market supply.

In some embodiments, the system may include an assignment interface to selectively assign a first sports player to a first position in a fantasy sports team and a second sports player to a second position in the fantasy sports team.

In some embodiments, the fantasy sports team is associated with a user of the system having a stock portfolio including at least one share of stock corresponding to the first sports player and at least one share of stock corresponding to the second stock player.

In some embodiments, the system may include a game engine to receive information of real-life performance of the first sports player, to convert the information into one or more fantasy points, and to add the one or more fantasy points to fantasy scores of one or more fantasy sports teams which include the first sports player.

In some embodiments, the game engine is to determine a winning fantasy sports team out of a plurality of fantasy sports teams based on a comparison of the fantasy scores of the fantasy sports teams.

In some embodiments, the fantasy sports teams virtually compete in a full draft competition in which the first sports player is exclusively assigned to a first fantasy team of the fantasy sports teams, wherein one or more shares corresponding to the first sports player are transferable to a second fantasy team of the fantasy sports teams.

In some embodiments, the fantasy sports teams virtually compete in a competition having a salary cap requiring that a sum of virtual salaries corresponding to sports players of the fantasy sports team be smaller than a maximal value.

In some embodiments, the system is to insert a quote of the real-life price of the stock in a media information item.

In some embodiments, a method may include, for example, registering for sale a stock, wherein the stock corresponds to a real-life sports player and wherein the stock is associated with a real-life price.

In some embodiments, the method may include storing information regarding ownership of shares of the stock.

In some embodiments, the method may include transferring one or more shares of the stock from a first user to a second user; and transferring a price of the one or more shares from an account of the first user to an account of the second user.

In some embodiments, the method may include updating the ownership information to reflect change of ownership of the one or more shares from the first user to the second user.

In some embodiments, the method may include detecting that a market demand for the stock is greater than a market supply of the stock; determining that a market failure exists; and registering for sale new shares of the stock based on a difference calculated between the market demand and the market supply.

In some embodiments, the method may include selectively assigning a first sports player to a first position in a fantasy sports team and a second sports player to a second position in the fantasy sports team.

In some embodiments, the method be used with regard to a fantasy sports team associated with a user having a stock portfolio including at least one share of stock corresponding to the first sports player and at least one share of stock corresponding to the second stock player.

In some embodiments, the method may include receiving information of real-life performance of the first sports player; converting the information into one or more fantasy points; and adding the one or more fantasy points to fantasy scores of one or more fantasy sports teams which include the first sports player.

In some embodiments, the method may include determining a winning fantasy sports team out of a plurality of fantasy sports teams based on a comparison of the fantasy scores of the fantasy sports teams.

In some embodiments, the method may be used with regard to fantasy sports teams that virtually compete in a full draft competition in which the first sports player is exclusively assigned to a first fantasy team of the fantasy sports teams, wherein one or more shares corresponding to the first sports player are transferable to a second fantasy team of the fantasy sports teams.

In some embodiments, the method may be used with regard to fantasy sports teams that virtually compete in a competition having a salary cap requiring that a sum of virtual salaries corresponding to sports players of the fantasy sports team be smaller than a maximal value.

In some embodiments, the method may include inserting a quote of the real-life price of the stock in a media information item.

In some embodiments, an apparatus may include, for example, a trading interface to transfer one or more shares of a stock, wherein the stock corresponds to a real-life sports player and wherein the stock is associated with a real-life price, from a first user of the apparatus to a second user of another apparatus.

In some embodiments, the trading interface is to indicate that a price of the one or more shares is transferred from an account of the first user to an account of the second user.

In some embodiments, the apparatus may include an assignment interface to selectively assign a first sports player to a first position in a fantasy sports team and a second sports player to a second position in the fantasy sports team.

In some embodiments, the fantasy sports team is associated with a user having a stock portfolio including at least one share of stock corresponding to the first sports player and at least one share of stock corresponding to the second stock player.

In some embodiments, the fantasy sports team virtually competes with one or more other fantasy sports teams in a competition based on a comparison of fantasy scores of fantasy sports teams, and wherein the competition includes a competition selected from a group consisting of: a full draft competition in which the first sports player is exclusively assigned to a first fantasy team of the fantasy sports teams, wherein one or more shares corresponding to the first sports player are transferable to a second fantasy team of the fantasy sports teams; and a competition having a salary cap requiring that a sum of virtual salaries corresponding to sports players of the fantasy sports team be smaller than a maximal value.

In some embodiments, the apparatus is to present a quote of the real-life price of the stock embedded in a media information item.

Some embodiments of the invention may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block-diagram illustration of a gaming system in accordance with some demonstrative embodiments of the invention;

FIG. 2 is a schematic illustration of multiple objects which may be used, in accordance with some demonstrative embodiments of the invention, by a game participant who participates as a sports agent or stocks broker;

FIGS. 3A and 3B are schematic illustrations of multiple objects which may be used, in accordance with some demonstrative embodiments of the invention, by a game participant who participates as a team manager;

FIGS. 4A and 4B are schematic illustrations of multiple demonstrative processes of stock trading in accordance with some demonstrative embodiments of the invention;

FIG. 5 is a schematic illustration of registration and trading of stocks corresponding to sports players in accordance with some demonstrative embodiments of the invention;

FIG. 6 is a schematic illustration of interactive embedded content in accordance with some demonstrative embodiments of the invention;

FIG. 7 is a schematic illustration of conversion between real-life parameters into virtual parameters in accordance with some demonstrative embodiments of the invention;

FIG. 8 is a schematic illustration of hierarchical organization of a gaming system in accordance with some demonstrative embodiments of the invention;

FIG. 9 is a schematic illustration of market monitoring and expansion in accordance with some demonstrative embodiments of the invention; and

FIG. 10 is a schematic flow-chart of a method of gaming and investing in accordance with some demonstrative embodiments of the invention.

### DETAILED DESCRIPTION

In the following detailed description, numerous specific details are set forth in order to provide a thorough understanding of some embodiments of the invention. However, it will be understood by persons of ordinary skill in the art that embodiments of the invention may be practiced without these specific details. In other instances, well-known methods, procedures, components, units and/or circuits have not been described in detail so as not to obscure the discussion.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities Within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of items” may include two or more items.

Although portions of the discussion herein may relate, for demonstrative purposes, to wired links and/or wired communications, embodiments of the invention are not limited in this regard, and may include one or more wired links, may utilize one or more components of wireless communication, may utilize one or more methods or protocols of wireless communication, or the like. Some embodiments of the invention may utilize wired communication and/or wireless communication.

Some embodiments of the inventions may include, for example, devices, systems and methods for creation and management of an online stock exchange market, which may be real-money driven or real-money based, supporting balanced supply-demand rates, and allowing market growth and market expansion.

In some embodiments, a first participant (denoted “Participant A”) may access a public web-site which may be used as an interface to a gaming system. Participant A may create a username and a password, and may pay a monetary amount to the gaming system through the web-site. For example, Participant A may pay an amount of 200 dollars through the web-site (e.g., using a credit card) to the gaming system. Accordingly, the gaming system may show to Participant A that he has an account with a positive balance of 200 dollars.

Participant A may purchase shares of stocks corresponding to sports players. The purchase can be made from public offerings of stocks by the administrator of the gaming system, and/or from other participants that already bought stocks (from public offerings, or from other participants).

For example, Participant A may purchase at a public offering four shares of stock of Player 1 at two dollars per share. In response, four shares of stock of Player 1 are added to the virtual portfolio of stocks owned by Participant A; and an amount of eight dollars are deducted from the account balance of Participant A and transferred to the gaming system administrator account. Optionally, a commission may be deducted from the account balance of Participant A for purchasing stock in the public offering.

Later, Participant A may further purchase from another participant (Participant B) three shares of stock of Player 2 at five dollars per share. In response, three shares of stock of Player 2 are added to the virtual portfolio of stocks owned by Participant A, and three shares of stock of Player 2 are removed or deducted from the virtual portfolio of stocks owned by participant B. In addition, an amount of 15 dollars is deducted from the account balance of Participant A, and an amount of 15 dollars is added to the account balance of Participant B. Optionally, a commission may be deducted from the account balance of Participant A for purchasing stock from another participant. Optionally, a commission may be deducted from the account balance of Participant B for selling stock to another participant.

Participant A may sell some or all of the stocks that he owns, to other participants, and may profit or may lose from such transactions. For example, Participant A may sell to another participant (Participant C) one share of stock of Player 1, out of the four shares of stock of Player 1 that participant A owns, for a price of 20 dollars per share. This may be possible, for example, because there may be a great demand for stock of Player 1, or because the real-life performance of Player 1 increased since Participant A bought the stock of Player 1, or because of market speculations, or due to other factors. Accordingly, this sale transaction yielded a gross profit of 18 dollars to Participant A (not taking into account optional commissions for buying and selling the stock).

In some embodiments, Participant A may accumulate profits from trading stocks corresponding to sports players. Upon multiple profitable transactions, the credit balance of the account of the Participant A may increase in comparison to the initial amount that Participant A paid to the gaming system. Participant A may request to “cash out”, namely, to receive back from the gaming system a payment in an amount substantially equal to the credit balance of his account. This route may allow Participant A to receive real-life monetary profits from virtual trading of stocks corresponding to sports players.

In some embodiments, in addition to or instead of trading stocks corresponding to sports players, Participant A may participate in competitions or challenges, and may gain real-life profits or prizes by winning such competitions or challenges. Participant A may own various number of shares of stocks corresponding to, for example, twenty soccer players. Participant A may construct a fantasy soccer team, by assigning one soccer player (of which Participant A owns at least one share of stock) into a particular position in accordance with formation requirements. For example, Participant A may own five shares of stocks corresponding to Player 17, who is (in real life) a soccer goalkeeper; Participant A may assign Player 17 to the goalkeeper position of his fantasy soccer team. Additionally, Participant A may own one share of stock corresponding to Player 32, who is (in real life) a soccer player; Participant A may assign Player 32 to a first striker position (e.g., out of three striker positions available for manning) in his fantasy soccer team. Participant A may thus assemble a partial or complete fantasy soccer team, based on players for which Participant A owns at least one share of stock.

In some embodiments, optionally, one or more requirements may be posed for constructing a fantasy sports team, for example, formation requirements, salary cap (or budget) requirements, or the like. For example, the gaming system may determine virtual salary amounts associated with a sports player, e.g., Player 17 may be associated with a virtual salary of one million dollars per year, Player 32 may be associated with a virtual salary of three million dollars per year, or the like. The participant may be required to meet budget requirements or salary cap requirements when assembling a fantasy sports team. For example, the gaming system may require that the total cumulative virtual salaries associated with all the sports players on the fantasy team does not exceed a particular budget (e.g., twenty million dollars), or that the cumulative virtual salaries associated with a subset of fantasy team players (e.g., the three strikers) does not exceed a particular budget (e.g., ten million dollars), or the like.

Upon assembly of the fantasy sports team, Participant A may register it under a unique name (e.g., “John's Lions”) and may submit his fantasy sports team to take part in a challenge or a competition according to its pre-defined rules. For example, the fantasy soccer teams of multiple participants (e.g., eight participants) that may be grouped together by the gaming system into a gaming “house”. The fantasy teams may score fantasy points which may be calculated by the gaming system based on real-life performance of sports players. For example, if Player 32 attends a real-life soccer match and scores a goal in real-life, then the gaming system may determine that each fantasy team owner (e.g., Participant A) who placed Player 32 on his fantasy soccer team in the relevant time period receives five fantasy points. Similarly, if Player 17 attends a real-life soccer match as a goalkeeper and receives a goal in real-life, then the gaming system may determine that each fantasy team owner (e.g., Participant A) who placed Player 17 on his fantasy soccer team in the relevant time period receives a negative amount of fantasy points, for example, −8 fantasy points. Accordingly, each fantasy team may accumulate fantasy points based on real-life performance of its players.

According to pre-defined rules of the competition or challenge, one or more rounds or matches may take place, or a pre-defined time period may elapse, or one or more conditions may be met (e.g., one of the fantasy teams reached a target fantasy score), until the competition or challenge ends. The gaming system may determine the winner(s) of the competition or challenge, for example, based on the number of fantasy points accumulated, based on targets reached, and/or based on other criteria. The gaming system may award a real-life prize (e.g., money, assets, a credit to the account balance, or the like) to the participant who owns the fantasy team declared as winner.

In some embodiments, one or more requirements may be placed by the gaming system in connection with competitions or challenges. For example, the gaming system may require that a fantasy team be manned and registered prior to a pre-defined date or time in which the competition begins; the gaming system may require that shares of stock corresponding to a sports player who is assigned on a fantasy team be “frozen” and may not be sold at certain time periods (e.g., when the player attends a real-life match); or other requirements. In some embodiments, the gaming system may require that shares of stock corresponding to a sport player who is assigned on a fantasy team be “frozen” and may be sold during their “freeze” state; however, if the participant that owns the shares of stock selects to sell all the shares of stock of the sports player who is assigned on his fantasy team, the gaming system may cancel his fantasy team's participation in the challenge, e.g., with regard to a current round. Other requirements or rules may be used in conjunction with “frozen” shares of stocks.

Although portions of the discussion herein may relate, for demonstrative purposes, to a requirement that a participant own at least one share of stock corresponding to a sports player in order to be able to assign that sports player into a fantasy team, embodiments of the invention are not limited in this regard, and may include other limitations. For example, some embodiments may require that a participant own at least N shares of stock (where N is a pre-defined positive number) corresponding to a sports player in order to be able to assign that sports player into a fantasy team; some embodiments may require that a participant own at least one share, or at least N shares, of stock corresponding to a sports player for a minimum time period (e.g., at least 12 hours, at least three days, or the like) in order to be able to assign that sports player into a fantasy team; other requirements or conditions may be used.

In some embodiments, calculations, statistics, prize entitlements, fantasy points calculation and entitlement, competitions and/or challenges may be based on, for example, a single match, multiple matches, consecutive or non-consecutive matches, a group or set of matches, a subset of matches, a round, a season, or the like. In some embodiments, a “round” may include, for example, a pre-defined group of real-life sport matches which may be combined together to form a round, e.g., by an administrator. For example, in some embodiments, fantasy points may be calculated and accumulated based on a round of multiple matches, and not necessarily on a single-match basis.

Although portions of the discussion herein may relate, for demonstrative purposes, to gaming systems utilizing real-life money or real-life monetary transactions, embodiments of the invention are not limited in this regard. For example, some embodiments may be used (in addition to or instead of real-life money) in conjunction with virtual currency, virtual money, fantasy money, fantasy currency, points, “stars”, other units or items, virtual credit or debit balances, or the like. In some embodiments, optionally, such virtual currency and/or non-real-life currency or virtual balances or virtual points may be converted into real-life currency and/or into real-life prizes or assets, or vice versa, for example, at substantially any time or at certain time periods or when pre-defined conditions are met (e.g., if the user accumulates a minimum amount of virtual currency).

Some embodiments may be used in conjunction with a “draft mode” or a “full fantasy mode”. For example, before the challenge begins, a draft may be conducted, allowing the participants to select their desired players on their turn, such that participants are not able to select a player that was already selected by another participant within his turn. In some embodiments, a draft mode may not utilize salary cap requirements, and changes in the roster of the fantasy team can be made only by performing a trade between players among the participants. For example, the gaming system may perform a draft process that produces (e.g., within its completion for each participant) the roster of the fantasy team that the participant assembled in a “sketch mode”. The system may filter the available players in the stock market, according to their status, for example, a “Free” status, a “Taken” status, a member of a “Cannot Pick” list, a “Waiver” status, or the like. For example, a participant may assign a “Taken” player to his fantasy team only throughout a successful trade with another participant who has the right for that player in the challenge. The trade may be performed only if both parties already own the relevant stocks, or are able to purchase the relevant stocks, until the beginning of the next round. The system may allow to perform the required market activities substantially automatically in order to execute the trades. For example, the system may automatically scan the available “ask” orders in the market; if there is a stock available for purchase in a price-range that was pre-defined by the relevant participant (or, by the two participants that are parties to the trade), then the system may substantially automatically execute a simultaneous sale of share(s) of that stocks between the relevant participants. In some embodiments, for each draft-mode challenge, a pre-defined threshold of maximal number of “Cannot Pick” players may be enforced. When a player is released from roster, he is dropped to a “Waiver List”; then, according to the continuation of the draft turns, a participant is able to assign or “claim” that player into his fantasy team. After a pre-defined period of time, if a “Waiver” player has not been claimed, he returns to the “Free Players” list. In some embodiments, the commissioner of the challenge and/or the majority of the participants may vote against a trade, and then cancel it.

Some embodiments may be used in conjunction with a “Salary Cap” or a “Budget”. For example, any participant may assemble players into his fantasy team as long as the total budget of the team (namely, the sum of all fantasy values of the players) is equal or lower to a pre-defined salary cap value of the challenge. In some embodiments, when a participant owns more than one stock of a given player, the system may automatically calculate and update his salary based on the lowest value.

Some embodiments may utilize a scoring system in accordance with one or more scoring schemes. In accordance with a first scoring scheme, scores are determined using the total fantasy points accumulated by the team members, e.g., based on statistics of their real-life performance. In contrast, a second scoring scheme (“Rotisserie”) may compute the fantasy points accumulated in each of every statistical category, and may calculate the total sum of “winnings”. For example, three categories may be used, of Goals, Assists, and Passes; the system determines the participant who accumulated the highest number of fantasy points for Goals, and will add fantasy points to the best fantasy team according to the Goals category; the process is performed separately for each category, e.g., for Goals, Assists and Passes. The best team may be, for example, the fantasy team who scored the highest points based on this calculation. Other suitable scoring schemes may be used.

Some embodiments may utilize eligibility requirements per rounds. For example, a fantasy team may be eligible for accumulating fantasy points and participating in the challenge, only if it meets the challenge rules, requirements and limits. For example, full formation may be required to be reached during the round and before the beginning of the last match of the round; salary cap limits should be met; “cannot pick” limits should be met; or the like. Other suitable requirements may be used.

Some embodiments may use or may allow retrieval of statistics, for example, substantially real-time statistics of real-life sporting events, slightly delayed statistics, delayed statistics, dynamically changing statistics, or the like.

The term “IPO” as used herein may include, for example, an initial public offering of shares of stock, or initial offering to sell shares of stock to the public or to a subset of participants, an initial registration of shares of stock for trading on the stock exchange, or the like. The term “SPO” as used herein may include a secondary public offering or a subsequent (e.g., third, fourth, etc.) public offering of shares of stock, a secondary or subsequent offering to sell shares of stock to the public or to a subset of participants, a secondary or subsequent registration of shares of stock for trading on the stock exchange, or the like. The term “IPO” as used herein may optionally include a SPO or multiple SPOs.

In some embodiments, a system may allow to create one or more new online stock exchange markets, driven by real money, where users may perform trades among themselves, for example, using “bid” and “ask” calls and orders on desired prices. The system allows to create and/or manage new and secured stock exchange markets, optionally powered by competitions for prizes, supporting balances supply and demand rate, and supporting growth in the number of traders and/or in the volume of the market. The participants of the competition may compete on one or more tasks or goals, for example, on having the best performing organized portfolio of stocks, which may represent, for example, real performing sports athletes and players.

Although portions of the discussion herein may relate, for demonstrative purposes, to an online stock exchange market associated with “sports” or with “fantasy sports”, embodiments of the invention are not limited in this regard, and may be used to create and/or manage online stock exchange markets in other fields or of other types, for example, the movies industry, the music industry, celebrities, political persons or parties, television or cinema related activities, hobbies, finance, entertainment, show business, performers, reality show contestants, movies, singers, actors, or the like.

Some embodiments of the invention may include elements of fantasy sports, sports betting, online gaming, online stock investing and trading, and/or other fields. In accordance with some embodiments, a “fantasy sports” game may include a game in which participants use a virtual budget to design their “dream team”, composed of their favorite real-life sports players. According to the selected sports players' performance in real-life sport events, the participants accumulate points for their teams. The participant with the highest score wins, and may optionally be entitled to receive a prize, e.g., a monetary prize.

For example, in some embodiments, a fantasy sport game of the type of “fantasy basketball” may be played. A participant may optionally be required to pay a participation fee. The participant may be allocated a virtual budget, allowing the participant to virtually purchase real-life basketball players and to thus assemble the participant's fantasy team. For example, the participant may be allocated a virtual budget of 10 million dollars, and may utilize the budget (or a portion thereof) to virtually purchase players, e.g., to virtually purchase the basketball player Kobe Bryant for 2 million dollars as Player 1, to virtually purchase the basketball player Shaquille O'Neal for 3 million dollars as Player 2, to virtually purchase the basketball player Tim Duncan I million dollars as Player 3, to virtually purchase the basketball player LeBron James for 0.7 million dollars as Player 4, and to virtually purchase the basketball player Allen Iverson for 1.35 million dollars as Player 5.

In accordance with some embodiments, real-life performance of the players in the fantasy team, may be translated into fantasy points, virtual points, fantasy money or virtual money. For example, if Player 1 took five rebounds in a real-life basketball match, the participant having Player 1 on his fantasy team may accumulate or receive fifty points; if Player 2 passed four assists in a real-life basketball match, the participant having Player 2 on his fantasy team may accumulate or receive eight points; if Player 3 scored ten points in a real-life basketball match, the participant having Player 3 on his fantasy team may accumulate or receive twenty points; or the like. For example, pre-defined lookup tables or functions or algorithms may be used to convert between real-life performance or actions of a player into fantasy points that a participant receives if that player is on the participant's fantasy team. In some embodiments, a real-life action may be converted into a positive amount of fantasy points, a negative amount of fantasy points, Or to a zero amount of fantasy point.

In some embodiments, a single participant may play, for example, against a pre-defined challenge, against a computer agent, against a random or pseudo-random fantasy team, against a computer-generated fantasy team, for a pre-defined period of time, or the like. In some embodiments, multiple participants may play, for example, against each other. For example, the participant who accumulated the highest number of fantasy points when a pre-defined time period elapses may be declared the winner, and may optionally receive a prize.

Some embodiments may include systems and tools for use by fantasy game operators, organizers and/or administrators. In some embodiments, some or all participants may be required to pay a fee in order to participate in the fantasy game, for example, a subscription based fee, a monthly fee, an annual fee, or the like. In other embodiments, some or all participants may participate for free in the fantasy game, and the game operator may receive revenue, for example, from advertising, for providing live or nearly-live scores or data, for providing delayed or non-delayed scores or data, for providing in-depth statistics, for updates, for additional content or services, or the like.

In accordance with some embodiments of the invention, sports players may be regarded as if they are stocks trade-able with real money, for example, using an online stock exchange market based on the sport fantasy game. For example, stocks may correspond to a particular sports player, and such stocks may be issued, traded, purchased, sold, or otherwise transacted upon. In some embodiments, the online stock exchange market may allow users to place orders (e.g., buy or sell), to use various bid or ask mechanisms, to write or trade options (e.g., a put option, a call option, “short” trading, or the like), or to perform other operations with regard to sports players based stocks.

In some embodiments, the operator of the online stock exchange market corresponding to sports players may generate revenue, for example, by initially issuing or initially selling to the market stocks in the first time; by charging commissions on various stock-related activities (e.g., a 5% commission from a buyer, a 3% commission from a seller when a profit is gained through the sale and this commission may be calculated from the profit, a commission for the mere holding of stocks or a particular type of stocks, a commission for placing orders or for placing certain types of orders, a “flat fee” commission, a commission or fee triggered only when a transaction yields a profit to at least one party, or the like); by collecting various fees, for example, for general participation, for specific participation in a certain competition or challenge or prize-bearing activity, for charging a fee per round or per time period (e.g., month, year, gaming season, or the like), and/or from other sources.

In some embodiments, a first participant may optionally pay a participation fee, and may be allocated a virtual budget, for example, for purchasing stocks corresponding to sports players. For example, the first participant may pay an annual participation fee, and may receive a virtual budget of 1,000 dollars. The first participant may purchase ten shares of stock corresponding to Player 1, for example, directly in a public offering of stocks issued by the operator of the online stock market exchange, each share having an initial price of two dollars. Then, Player 1 may take five rebounds in a real-life basketball match, thereby causing an increase in the price of its stock, for example, from two dollars to three dollars. The first participant may then sell his ten shares of stock of Player 1 (or a portion of his ten shares), to a second participant who pays to the first participant three dollars per share. As demonstrated, real-life performance of Player 1 in actual sporting events or matches may cause modifications (e.g., increase or decrease) in the virtual price associated with the stock of Player 1 in the fantasy game stock exchange market, in addition to modification in fantasy points (e.g., accumulation of additional fantasy points) of participants that have Player 1 in their fantasy team of players. In some embodiments, the price of stocks corresponding to a sports player may not be directly or indirectly affected by his real-life performance, may not be directly or indirectly affected by fantasy points accumulated due to his real-life performance, and/or may be determined substantially exclusively based on supply and demand of traders in the stock market. For example, in some embodiments, real-life performance of a sports player may not necessarily modify (and may not automatically modify) the price of stock of that sports player.

In some embodiments, a correlation may exist between real-life performance of a sports player and the supply/demand forces in the online stock market exchange in which stocks corresponding to that player are traded, and the stock price may reflect the player's real-life performance. However, in some embodiments, other and/or additional parameters may affect the price of stocks corresponding to a sports player, for example, the stock price may decrease if the real-life player is injured, the stock price may decrease if the real-life player is associated with negative real-life characteristics (e.g., is criminally arrested, is undergoing a divorce, is investigated for drug use, or the like), the stock price may increase or decrease based on rumors or speculations, or the like. In some embodiments, the price of stock corresponding to a sports player may increase, but need not necessarily increase, after positive real-life performance of that player, for example, due to such other factors that may affect the stock price. In some embodiments, the prices of stock corresponding to a sports player may not necessarily be affected (exclusively, or partially, or at all) by real-life events or real-life performance of that player, but rather may be affected substantially exclusively by supply and demand of a “free market” in the virtual stock exchange of sports players stocks.

In some embodiments, a user may participate as one or more types of participants, for example, a regular user or trader able to buy and sell stocks corresponding to sports players, a stock broker, a manager, a commissioner, an analyst, or the like.

In some embodiments, price data associated with a stock corresponding to a sports player may be modified in substantially real time, and may be presented in substantially real time, for example, using a ticker-symbol feed or mechanism which may be embedded in sport events being broadcast. For example, a television screen may present a live real-life basketball game, in which Player 1 participates, and a ticker tape may scroll at the bottom of the screen showing that the stock price associated with Player 1 is four dollars. During the real-life basketball game, Player 1 may score three points by shooting from the three-point zone, and shortly thereafter his stock price may increase from four dollars to five dollars. Accordingly, the ticker tape scrolling on the screen may be updated to indicate that the new stock price is five dollars, and that the stock price is trading at a 20% increase. In some embodiments, optionally, the ticker tape may indicate transaction information, for example, volume information, e.g., an indication that ten shares were recently sold at the price of five dollars per share. Other information may be presented, for example, market statistics, market analysis, or the like. In some embodiments, optionally, direct market activity may be presented and/or performed (e.g., interactively, in substantially real time) through interactive television (e.g., using a remote control or a mobile phone), mobile phones, computers, or other devices. In some embodiments, while viewing a live broadcast of sports match on television, live statistics may be presented on the television screen, together with market data of the relevant sports player(s) (e.g., price, change in price, volume, a “best buy” price and available quantity, or the like); and a participant may purchase share(s) of stock of sports player(s) using the remote control and/or a mobile phone directly, and may perform other activities, for example, constructing or modifying his fantasy team.

In some embodiments, stock-related information or alerts may be presented and/or delivered using various devices and methods, for example, mobile phones, cellular phones, beepers, pagers, one-way pagers, two-way pagers, computers, newspapers and magazines, World Wide Web web-sites or web-pages, Internet communication, TCP/IP communication, interactive television, personal digital assistant (PDA) devices, electronic mail (email) devices, email messages, instant messages, short messaging service (SMS) message, multimedia short messages service (MMS), wired communication, wireless communication, or the like.

Some embodiments may utilize multiple distribution channels or multiple mediums in order to transmit information and/or to perform transactions with regard to stocks corresponding to sports players. For example, a first participant may use a first device (e.g., a personal computer) and a first channel (e.g., a trading web-site) to place a “buy” order with regard to ten shares of Player 1; a second participant may use a second device (e.g., a remote control or a keypad) and a second channel (e.g., interactive television) to place a “sell” order with regard to ten shares of Player 1; and the stock market system may collect the two orders and match between them, such that a sale of ten shares from the first participant to the second participant is transacted. Optionally, a fee or commission may be paid to the trading web-site that the first participant uses, and/or to the interactive television service provider that the second participant used. The first and second channels may be of different types, may utilize different types of communications or mediums, and may be owned by different entities. In some embodiments, multiple operators may be used for completion of a stock trade, for example, using a common platform (e.g., personal computers) or using different platforms (e.g., a mobile phone used by a seller and a personal computer used by a buyer), and the stock trade may be executed by a single common stock exchange capable of marking or identifying the different operators and capable of sharing with them fees or revenues gained from transactions.

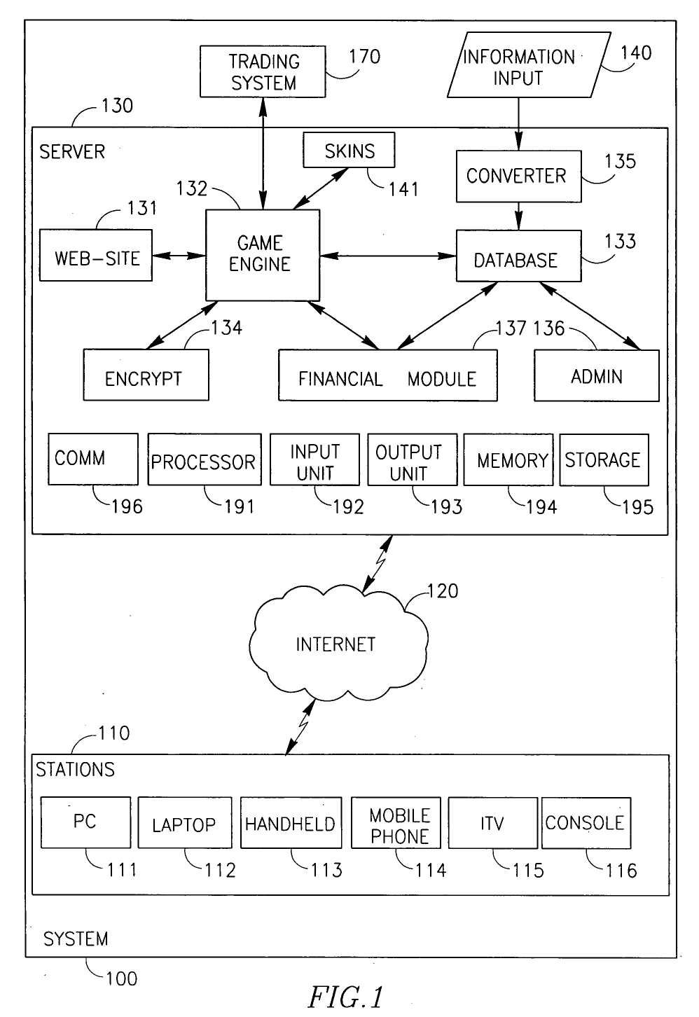

FIG. 1 schematically illustrates a block-diagram of a gaining system 100 in accordance with some demonstrative embodiments of the invention. System 100 may include, for example, a server 130 able to communicate with multiple stations 110, for example, utilizing the Internet 120.

System 100 may utilize the Internet computer network, or other suitable computer network, for example, a TCP/IP based network, TCP/IP communication, local area network (LAN), wide area network (WAN), wired or wireless communications, a shared access medium, or the like. System 100 may utilize client/server architecture, peer-to-peer architecture, or other suitable architectures.

System 100 may include multiple stations 110, each station adapted to allow a user to participate in the online game operated by system 100. The stations 110 may include, for example, a personal computer 111, a laptop computer 112, a handheld computer 113, a mobile phone 114, an interactive television device 115, a console gaming device 116, or the like. Stations 110 may utilize one or more operating systems, for example, Windows, Linux, Mac OS, or the like. Stations 110 may be connected to the Internet 120, for example, using a direct connection, an indirect connection, an intranet, a local area network (LAN), a wireless connection, a wired connection, an Internet service provider (ISP), an online service provider, or the like.

Stations 110 may participate in the online game of system 100 using one or more methods. For example, in some embodiments, personal computer 111 may utilize an HTML-based platform, for example, a World Wide Web browser (e.g., Microsoft Internet Explorer, Netscape Navigator, Mozilla Firefox, or the like), optionally using a plug-in or Active-X control or extension to allow dynamic content and/or rich content and/or interactive capabilities and/or real-time capabilities (for example, Flash objects, Shockwave objects, Java applets, AJAX, HTTP-Push, or the like). The server 130 may host a web-site 131, which personal computer 111 may access in order to participate in the online game. For example, the web-site 131 may be used as an interface allowing the personal computer 111 to interact with a game engine 132 of server 130.

In other embodiments, for example, mobile phone 114 may include a stand-alone application, e.g., a software application which can be downloaded to the mobile phone 114 and may be executed thereon, a program which may be pre-installed or otherwise embedded in mobile phone 114 (e.g., by a manufacturer or provider thereof), or the like. The stand-alone application may be able to interact with the game engine 132 of server 130, for example, without the interface of web-site 131. Other suitable architectures may be used.

Server 130 may further include a database 133, for example, able to store game-related information, e.g., stock information, stock names or symbols, stock prices, orders, bid and ask information, past history of orders or transactions, statistics, or the like. Stations 110 may be utilized to send signals or messages to server 130, for example, a message indicating a “buy” order, a message indicating a “sell” order, a signal requesting to show portfolio balance, or the like. In response, the server 130 may optionally execute a query on the database 133, and/or may modify the content of one or more records stored in database 133, and may then send back feedback to the relevant station(s) 110. In some embodiments, optionally, some or all communications between stations 110 and server 130 may be encrypted, for example, using an encryption unit 134, e.g., utilizing 128-bit Secure Sockets Layer (SSL).

Server 130 may optionally be able to receive input 140, for example, information indicating real-time performance of sports players. A converter module or unit 135 may optionally filter, analyze, modify and/or convert the received input 140 and may generate updates to the information stored in database 133. For example, a live data feed may be used to provide input 140 that Player 2 scored three points; converter 135 may process the received input 140 and may prepare a data item suitable for updating the information stored in database 133; the updating operation may be performed, for example, by the converter 135 or by the game engine 132. In some embodiments, input 140 may be received and processed substantially automatically, e.g., utilizing a real-time data feed. In other embodiments, input 140 may be received and/or processed manually or semi-automatically, for example, by an administrator of server 130 who may perform reviewing operations, updating operations, filtering operations, or the like.

In some embodiments, server 130 may log, record and/or archive in database 133 substantially all operations or queries performed by stations 110. Server 130 may generate reports associated with market activity, for example, to be utilized by game participants for their gaming decisions, to be utilized by administrators of server 130 in order to supervise and inspect suspicious or fraudulent activity, or the like.

in some embodiments, stations 110 may include an internal memory or cache or database or storage medium, allowing stations 110 to internally store at least some of the information relevant to the participation in the online game. For example, personal computer 11 may locally store a history of recent transactions, to allow fast retrieval and/or off-line retrieval, and may optionally allow off-line or independent data processing (e.g., statistical analysis). In some embodiments, for example, a local repository of personal computer 111 may be used for playing, viewing, entering and/or modifying data, and upon confirmation by the user, or upon connection to the Internet 120, the relevant information or queries or instructions may be sent to server 130. Other suitable mechanisms may be used.

In some embodiments, stations 110 may interact with server 130 substantially directly over the Internet 120. For example, personal computer 111 may transmit a “buy” order directly to server 130, and game engine 132 may execute the received order and may update the database 133. In other embodiments, a third-party electronic trading system 170 may be used. For example, the trading system 170 may execute a modified version of the online game, may receive and/or aggregate orders from multiple stations 110, and may transmit (e.g., electronically and securely) the aggregated data for execution by game engine 132 and/or updating of database 133. In some embodiments, trading system 170 may present its version of the game to stations 110 in a particular context, for example, in response to a search query, in conjunction with presenting sporting events scores or updates, or the like.

Server 130 may optionally include an administration module 136, for example, to allow an administrator to control or modify the operation of server 130, to allow the administrator to generate reports, to supervise the operation of server 130, to inspect the content of database 133, or the like.

In some embodiments, for example, the administration module 136 may include tools to monitor the market, gather information regarding each stock and/or each user activity, identify problems or potential problems, identify potential abuse of the system, implement anti-fraud mechanisms, identify “unhealthy” market symptoms (e.g., the market provides stocks only to a very small amount of users), or perform other tasks. The administration module 136 may further allow controlled operations of market growth support, introduction of new stocks in IPOs, modification or cancellation of scheduled IPOs, SPOs, Splits or similar operations that may typically be performed with caution, moderately, and to maintain a “healthy” market in which supply and demand forces are effective.

In some embodiments, optionally, the gaming system may perform a “split” when one or more conditions are met, for example, when the “closing” price of a player's stock is equal or higher than a pre-defined value during a pre-defined period of time. The system may thus multiply the number of shares owned by the participants (e.g., multiply by a positive integer K) and may divide the price of each shares (e.g., divide by the positive integer K).

In some embodiments, at the initial creation of the stock exchange, a relatively small amount of stocks may be registered and offered for sale by the operator of the gaming system. This may create a solid market for the first users who begin to purchase stocks at the IPO and trade the stocks among themselves. Once the number of users increases significantly, the gaming system may determine to adjust the market in order to accommodate and support the growth of potential liquidity, for example, by issuing new shares. One or more algorithms or functions may be used by the gaming system to determine the timing for additional issuing of shares and the volume of additional shares issued from time to time, taking into account past performance of the market, number of users, increase in number of users, forecast of new users that are expected to join the gaming system (e.g., based on data indicating the number of new visitors to the web-site 131 in a particular time frame), and other parameters.

Some embodiments may perform one or more types or processes of market monitoring, for example, wide monitoring, specific monitoring, or the like. Wide monitoring may substantially continuously track, count and calculate the total supply, the total demand, and the “gap” or difference between the supply and demand in each stock exchange. The data may be calculated per position (namely, a position of a sports player, e.g., striker, defender, goalkeeper, or the like) in the market. For example, in a demonstrative embodiment, the stock exchange may include three positions, namely, strikers, defenders, and goalkeepers; with regard to strikers, a difference of 8 may be determined between a calculated demand of 62 and a calculated supply of 54; with regard to defenders, a difference of 37 may be determined between a calculated demand of 40 and a calculated supply of 3; and with regard to goalkeepers, a difference of 4 may be determined between a calculated demand of 109 and a calculated supply of 105.

In order to compute the supply in the market per each position, the system may count the total available stocks in the entire market (e.g., all the players per position) by calculating the sum of all the Ask orders of each player (e.g., not only the best Ask order which may be shown to users) and adding the number of successful Sell transactions during a pre-defined time period (e.g., all trades performed within the last 24 hours), thereby producing the total supply per each position. Other suitable calculations or estimations may be used.

In order to compute the demand in the market per each position, the system may calculate a weighted average according to weight rates (e.g., which may be set by the administrator). In this process, the system may differentiate between various types of users, for example, registered users who joined at least one challenge, registered users who started to assemble a fantasy team in “sketch mode”, and registered users who purchased at least one share of stock. Each type of users may be associated with a corresponding weight rate, for example 100% weight rate for the registered users who joined at least one challenge, 80% weight rate for the registered users who started to assemble a fantasy team in “sketch mode”, and 40% weight rate for the registered users who purchased at least one share of stock.

With regard to a registered user who joined at least one challenge, the system may calculate the difference between the required formation of the specific challenge and the current portfolio of the user. For example, a user may register for a challenge that requires a formation of three strikers, three defenders, and one goalkeeper; however, the user's portfolio may currently have stocks corresponding to two strikers, no defenders, and four goalkeepers. Accordingly, the system may determine a demand per position of one striker and three defenders, e.g., based on the number of players that are “missing” from the user's portfolio in order to fully man his fantasy team in accordance with formation requirements. In some embodiments, if a user registered to more than one challenge, the base for the calculation may be, for example, the average formation or the minimal formation of all the relevant challenges.

With regard to a registered user who started to assemble a fantasy team in “sketch mode”, the system may calculate the demand per position using a process similar or identical to the process described with regard to registered users who joined at least one challenge, and may use the required formation(s) of the relevant challenge(s). However, in some embodiments, the weight rate associated with a demand calculated for the group of users who started to assemble a fantasy team in “sketch mode” may be smaller than the weight rate associated with a demand calculated for the group of users who joined at least one challenge. Other suitable calculations or estimations may be used.

With regard to users who purchased at least one share of stock, the system may calculate the demand per position based on the average (or minimal) formation requirement in the system (e.g., based on substantially all the active challenges), and may calculate the difference between the average formation and the portfolio of any user who purchased at least one share of stock. Other suitable calculations or estimations may be used.

In some embodiments, each calculated difference or “gap” may be multiplied by a corresponding weighted rate, thereby calculating the total demand per position. For example, the demand calculated for a striker position based on registered users who joined at least one challenge may be 42 strikers; this number may be multiplied by a weighted rate of 100%, thereby producing 42 strikers. The demand calculated for a striker position based on registered users who started to assemble a fantasy team in “sketch mode” may be 15 strikers; this number may be multiplied by a weighted rate of 80%, thereby producing 12 strikers. The demand calculated for a striker position based on registered users who purchased at least one share of stock may be 25 strikers; this number may be multiplied by a weighted rate of 40%, thereby producing 10 strikers. The weighted demand-per-group may be added together (namely, 42 and 12 and 10), thereby producing the total demand in the market for strikers (namely, 64). Other suitable calculations or estimations may be used.

In some embodiments, specific monitoring may be performed, for example, with regard to specific market data corresponding to each player's stock. The specific monitoring may include, for example, monitoring of stock price, volume of shares traded, price change, and other parameters.

In some embodiments, growth of number of shares in the market may be achieved by offering more shares for sale in an IPO/SPO, while keeping minimal affection on the market. For example, in some embodiments, a secondary or subsequent public offering need not be performed for a stock that already enjoys solid activity with high volume and proper supply and demand rates. In other embodiments, in contrast, a secondary or subsequent public offering may be performed particularly for a stock that already enjoys solid market activity, for example, since it may be efficient or convenient to add new shares of the stock to a “healthy” market.

In some embodiments, a suitable function or algorithm may be used to calculate a sell price-per-share at the IPO/SPO, as to not affect pricing competition in the market. In some embodiments, an automatic price setting may be performed “behind” the offers of participants. For example, the system may automatically move the SPO stocks “behind” the offers of participants. For example, the system may automatically place the SPO stocks in the market activities Ask orders “behind” the best available Buy offer, and may update the offer according to the updated best offers. The system may calculate the average price of the stock during a predefined period of time prior to the SPO date and time (“minimal limit”), and may continue to calculate the updated average as long as the SPO process takes place. In one embodiment, for example, there may be an Ask order for five shares of stock for ten dollars per share, and the system determines to perform a SPO to sell additional 50 shares; the SPO shares may be placed “behind” the five shares of stock offered for sale by participants. If the five shares of stock are sold and the next offer is three shares at eight dollars per share, the SPO stocks may be moved “behind” this offer, such that 53 shares may be available for eight dollars per share. In some embodiments, exceptions may be used, for example, when the price is lower than a predefined value, thereby limiting the automatic update; the minimal limit may be automatically defined through calculation of the average price during a predefined period of time prior to the SPO date and time. Other suitable processes may be used, automatically and/or manually, in conjunction with SPOs.

In some embodiments, a constantly increasing demand for a particular stock, which is not fulfilled even at high bidding prices, may indicate to the gaming system that an additional offering of that particular stock is required in order to accommodate the market. For example, if for a continuous period of time a large number of “bid” orders were placed, at relatively high prices, but no “sell” orders and no “ask” orders were placed in response, then the system may determine that a SPO is required. The IPO/SPO price may be determined based on multiple parameters, for example, market activity, bid prices, ask prices, value assessment functions, or the like. In some embodiments, participants may trade stocks while a SPO takes place; for example, a participant's “bid” order may bypass the IPO/SPO mechanism and may be met by a “sell” order from another participant.

In some embodiments, the administration module 136 may include anti-fraud tools to identify, prevent or stop potential fraud attempts or suspicious activity. For example, suspicious organized attempts to raise or lower stocks price unnaturally and without logical proportions may be identified. The identification may be performed based on suspicious patterns of behavior of a group of users or between groups of users, and/or based on monitoring of the stock market itself to detect trading of shares in abnormal values or abnormal volumes. In some embodiments, a value assessment factor may be utilized, which is not influenced directly by a single trade or a few trades, but rather is calculated based on a combination of real performance assessment, calculation taking into account history of activity in various time frames, and/or other parameters.

In some embodiments, the fantasy value factor may be based on multiple components, for example, market performance data and sports performance data. The fantasy value factor may be automatically changed through the calculation of a weighted average of changes according to different time frames. For example, in some embodiments, the system may set, calculate and update the fantasy value of each player as follows. An initial fantasy value margin parameter may be used, and the system may allow the administrator to set and/or change the fantasy value margin parameter that may be used to automatically set the initial fantasy value according to the IPO price. Similarly, minimum and/or maximum fantasy values may be set per position and per specific players. The system may automatically stop the automatic update of the fantasy value when it reaches the minimal or maximal value, and may continue to update it only when the value is between the minimum and maximum values again. Fantasy value calculations may be used in conjunction with a participant's portfolio; for example, the system may stop the updating process of the fantasy value of a player when a participant purchases stock of that player, and may treat this fantasy value as the player's salary in the fantasy team(s) on the challenge(s); and may update the player's fantasy value (the “salary”) according to the lowest fantasy value when there are more than one share of stock of that player in the portfolio with different fantasy values.

The system may automatically update the fantasy value of each player according to the market and sports performance components, for example, as follows. A market component may be used, such that the system may track the price changes during several period of times and may calculate the weighted average of price change. With regard to the market component, the system may provide the ability to set and change the weight (e.g., percentage) of each period of time for tracking and calculating, and/or the duration of time of each period of time for tracking and calculating. A sport performance component may be used, such that the system may track the difference between the average (forecast) fantasy points per match/round and the actual fantasy points accumulated by the player according to his statistics, and may calculate the weighted average. With regard to the sports performance component, the system may provide the ability to set and change the weight (e.g., percentage) of each period of time for tracking and calculating, and/or the duration of time of each period of time for tracking and calculating.

Furthermore, the system may provide the ability to set and change the “balanced” average of fantasy values per position. An average of fantasy values per position settings may be used, and the system may provide the ability to set and change the difference in percentage and fantasy value units between the tracked average per position and the “balanced” average, and may alert the administrator when the difference is reached or exceeded, thereby preparing a normalization process. The system may perform normalization of substantially all fantasy values, for example, according to the difference between the current average and the “balanced” average. The system may provide the ability to update the fantasy values while keeping the relative values, in order to get the current average equal to the “balanced” average upon the authorization of the administrator. The system may provide the administrator the ability to change and update the fantasy values of all players in the market manually (e.g., between seasons), and may alert the participants when their existing fantasy teams exceed the salary cup according to the updated parameters. Other suitable calculations may be used.

In some embodiments, the fantasy value may be calculated by taking into account multiple parameters, for example, a market performance parameter and a sports performance parameter. The fantasy value may be utilized to ensure that the evaluation of players is updated according to their real-life performance (e.g., Sports Performance which is based on the statistics and the conversion of the statistics into fantasy points) as well as on supply and demand forces (e.g., market data which is based on the stock price changes according to the transactions in the stock market). The evaluation may be performed automatically by the system according to weighted average, for example, during one or more periods of time, in order to prevent from a single match result or a single statistical result or a single market transaction to influence excessively the evaluation value, namely, the fantasy value.

Calculation of the market component in accordance with some embodiments may be demonstrated using the following table, denoted Table 1:

TABLE 1

| (A) Time period | (B) Weight | (C) Data | (D) Weighted Data |
|---|---|---|---|
| Daily (1-day period) | 10% | +3.0% | +0.3% |
| 5-days period | 40% | +2.5% | +1.0% |
| 30-days period | 50% | +0.9% | +0.45% |

In Table 1, each line corresponds to a time period, for example, measured in days (e.g., 1 days, 5 day, 30 days). Column A indicates the time period per line. Column C indicates data (e.g., stock price change) corresponding to the time period of column A. Column B indicates the relative weight (e.g., in percentage value) of each line in calculation of the weighted average (or in calculation using another weighted formula). For example, in the demonstrative example of Table 1, a significant weight (50%) is associated with data corresponding to a 30-days period, whereas a relatively small weight (10%) is associated with data corresponding to a one-day period. Column D indicates the weighted data, for example, received by multiplying a data item from column C with its corresponding weight from column B. The market component may be equal, for example, to the sum of items in column D, namely, 1.75%.

Calculation of the sports performance component in accordance with some embodiments may be demonstrated using the following table, denoted Table 2:

TABLE 2

| (A) Number of | | | |
|---|---|---|---|
| matches/rounds | (B) Weight | (C) Data | (D) Weighted Data |
| 1 match | 10% | −1.1% | −0.11 |
| 1 round | 20% | −0.2% | −0.04 |
| 3 rounds | 30% | +0.3% | +0.09 |
| 7 rounds | 40% | +0.8% | +0.32 |

In Table 2, each line corresponds to a number of matches or rounds (e.g., 1 match, 1 round, 3 rounds, 7 rounds). Column A indicates the number of matches or rounds. Column C indicates data (e.g., a difference between the average fantasy points per match/round from last year to the actual data) corresponding to the number of matches or rounds of column A. Column B indicates the relative weight (e.g., in percentage value) of each line in calculation of the weighted average (or in calculation using another weighted formula). For example, in the demonstrative example of Table 2, a significant weight (40%) is associated with data corresponding to 7 rounds, whereas a relatively small weight (10%) is associated with data corresponding to a single match. Column D indicates the weighted data, for example, received by multiplying a data item from column C with its corresponding weight from column B. The sports performance component may be equal, for example, to the sum of items in column D, namely, 0.26%.

In some embodiments, the fantasy value may be calculated based on a weighting formula that takes into account, and not necessarily with the same weight, the market component and the sports performance component. For example, in some embodiments, the market component may have a weight of 40%, whereas the sports performance component may have a weight of 60%. For example, the fantasy value (or, the automatic modification of the fantasy value) may be equal to a sum of the weighted market component (0.70%, which is 40% of 1.75%) and the weighted sports performance component (0.156%, which is 60% of 0.26%), namely, 0.856%. Other suitable calculations may be used.

In some embodiments, the administration module 136 may optionally be able to generate evaluation reports, based on processing of real-time market data, combined with real performance statistics, thereby yielding in-depth evaluation of players and teams and taking into account popularity and performance. The evaluation reports may be utilized by third parties or selected users of the system, for example, media companies, sports teams, sport agents, or the like. In some embodiments, a “moneyball rate” may be calculated and/or utilized, for example, a rate between the fantasy points (the sports performance) and the fantasy value (the market worth).

Some embodiments may associate between a player's stock and its appearance in one or more fantasy teams or challenges. For example, the system may show and link each owned player's stock that is assigned to a fantasy team to the relevant fantasy team(s). The system may alert the user when he attempts to sell a stock associated in a fantasy team, and may open the relevant window(s) with the relevant fantasy team(s) tabs, optionally indicating the assigned team(s). In some embodiments, the system may cancel the appearance of a player in the fantasy team or challenge if the participant sells the entire quantity of stock of that player.

Server 130 may optionally include, or may be operable associated with, a financial module 137 able to handle incoming payments and/or outgoing payments. The financial module 137 may receive incoming participation fees from participants (e.g., by credit cards, debit cards, cash, checks, direct debits to bank accounts, money orders, money transfers, wire transfers, PayPal or similar online payments, cash equivalents, micro-payments, pre-paid cards, or the like); may collect fees from participants (e.g., for participation, for selling stocks, for buying stocks, or the like); may pay prizes to participants (e.g., for winning a prize in a competition); may pay the outstanding balance to participants that desire to “cash out” their balance; may pay commissions to distribution channels, trading web-sites, service providers, or the like; may collect payments from advertisers and sponsors; or perform other finance-related operations.

In some embodiments, server 130 and/or components thereof may be implemented using a server computer, for example, having a processor 191, an input unit 192, an output unit 193, a memory unit 194, a storage unit 195, and a communication unit 196. Processor 191 may include, for example, a central processing unit (CPU), a digital signal processor (DSP), a microprocessor, a host processor, a controller, a plurality of processors or controllers, a chip, a microchip, one or more circuits, circuitry, a logic unit, an integrated circuit (IC), an application-specific IC (ASIC), or any other suitable multi-purpose or specific processor or controller. Input unit 192 may include, for example, a keyboard, a keypad, a mouse, a touch-pad, a stylus, a microphone, or other suitable pointing device or input device. Output unit 193 may include, for example, a cathode ray tube (CRT) monitor or display unit, a liquid crystal display (LCD) monitor or display unit, a screen, a monitor, a speaker, or other suitable display unit or output device. Memory unit 194 may include, for example, a random access memory (RAM), a read only memory (ROM), a dynamic RAM (DRAM), a synchronous DRAM (SD-RAM), a flash memory, a volatile memory, a non-volatile memory, a cache memory, a buffer, a short term memory unit, a long term memory unit, or other suitable memory units or storage units. Storage unit 195 may include, for example, a hard disk drive, a floppy disk drive, a compact disk (CD) drive, a CD-ROM drive, a digital versatile disk (DVD) drive, or other suitable removable or non-removable storage units. Communication unit 196 may include, for example, a wired or wireless network interface card (NIC), a wired or wireless modem, a wired or wireless receiver and/or transmitter, a wired or wireless transmitter-receiver and/or transceiver, a radio frequency (RF) communication unit or transceiver, or other units able to transmit and/or receive signals, blocks, frames, transmission streams, packets, messages and/or data. Communication unit 116 may optionally include, or may optionally be associated with, for example, one or more antennas, e.g., a dipole antenna, a monopole antenna, an omni-dircctional antenna, an end fed antenna, a circularly polarized antenna, a micro-strip antenna, a diversity antenna, or the like. In some embodiments, the components of server 130 may be enclosed in, for example, a common housing, packaging, or the like, and may be interconnected or operably associated using one or more wired or wireless links. In other embodiments, for example, components of server 130 may be distributed among multiple or separate devices, may be implemented using a client/server configuration or system, may communicate using remote access methods, or the like.

In some embodiments, server 130 may utilize one or more skins 141, for example, branded skins to accommodate various distribution channels or service providers. For example, a distribution channel may present a trading interface having a unique skin 141, for example, a functional design or buttons or interface which creates a unique “look and feel”, optionally embedding a logo or a symbol associated with the distribution channel. The skins 141 may be presented or utilized, for example, using one or more web-sites 131, using one or more of the various stations 110, or the like. The skin 141 may allow communication utilizing the same unified stock exchange and challenges, and may be able to report the specific activities conducted through the skin 141 as preparation for sharing revenues with the skin 141 operator.

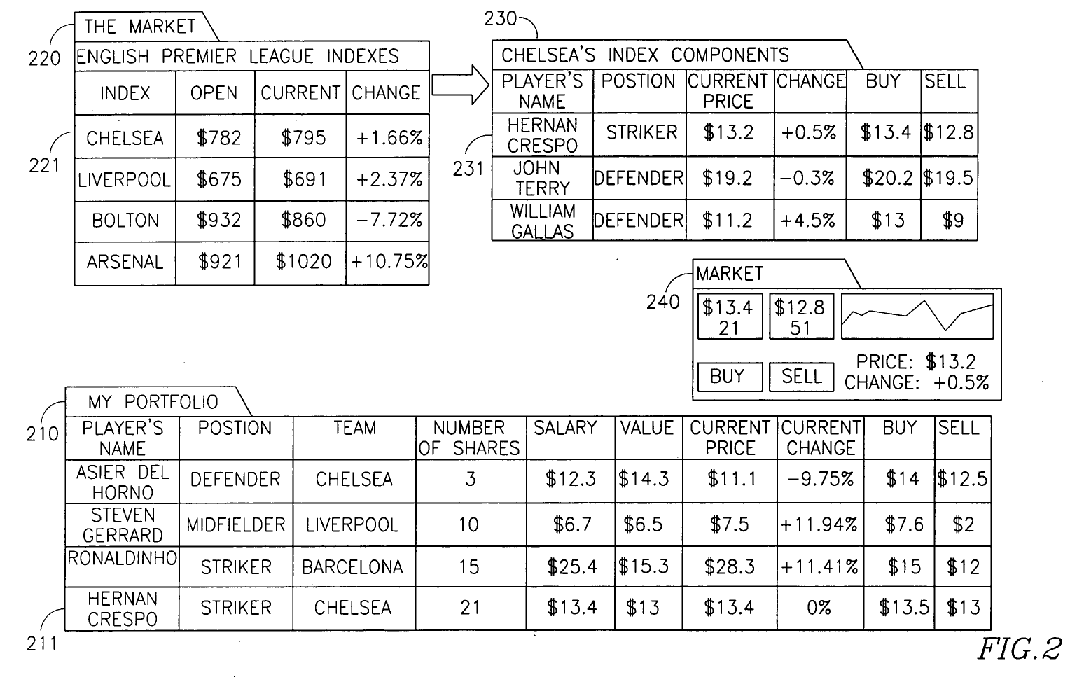

FIG. 2 schematically illustrates multiple objects which may be used, in accordance with some demonstrative embodiments of the invention, by a game participant who participates as a sports agent or stocks broker. The participant may have a virtual portfolio 210 showing for each player his name, position, team, salary, number of shares owned, value of shares owned, current price of share, current change (in points and/or in percentage), current “bid” offers, current “ask” offers, and/or other portfolio information. Optionally, a sports team may be associated with a stocks index of a representative aggregation of shares corresponding to the players that are members of that team in real-life. Accordingly, team index data 220 may be shown, and a detailed breakdown of the index components 230 may be shown for a selected team index. The participant may, for example, select a particular team index 221, select a particular player 231 of that team, view market activity 240 associated with that particular player, and may buy or sell stocks corresponding to that particular player, thereby modifying his virtual portfolio 210 and the particular slot 211 of that particular player 231 in the portfolio 210.

In some embodiments, portfolio items may be bought and sold, for example, using bid and ask mechanism, using buy orders and sell orders, using manual or automatic trading mechanisms, using a trading mechanism triggered automatically when a pre-defined condition is met, or the like.

In some embodiments, Bid and Ask orders may be canceled (e.g., at any time before their fulfillment) manually or automatically utilizing an expiration time/date setting, and/or may be edited (e.g., with regard to price, quantity, automations and/or expiration), for example, as long as the orders are still “open” and not converted into a completed “Buy” or “Sell”.

In some embodiments, stocks corresponding to sports players are assets, virtual properties owned by the game participants who bought them, without an expiration date. By trading these stocks among themselves, the game participants may earn real money profits or may incur real money losses. For example, a participant may earn a profit by buying at a first price a stock corresponding to a particular sports player, and by selling that stock at a second, higher, price.

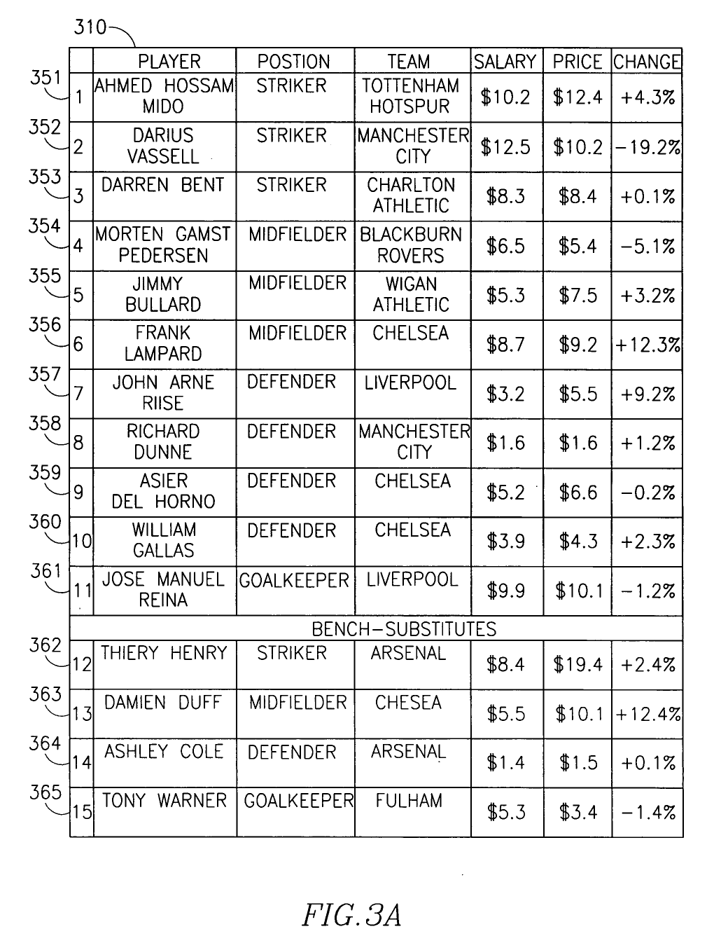

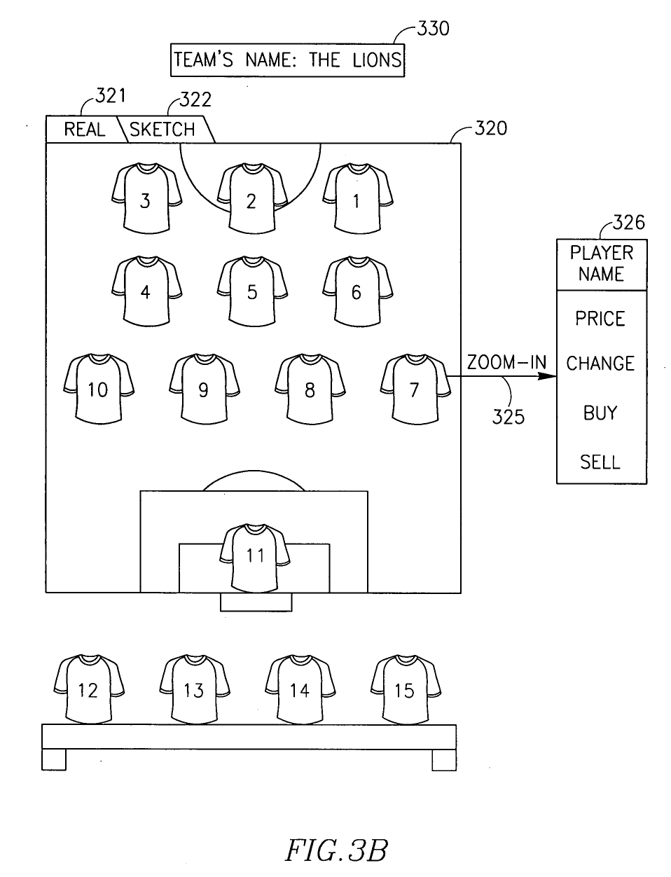

FIGS. 3A and 3B schematically illustrate multiple objects which may be used, in accordance with some demonstrative embodiments of the invention, by a game participant who participates as a team manager. In some embodiments, some or all of the objects shown in FIGS. 3A and 3B may be presented or used in a single screen or window, a common screen or window, a single interface, a common interface, side-by-side, or the like. In other embodiments, some or all of the objects shown in FIGS. 3A and 3B may be presented or used in multiple screens, windows and/or interfaces.

The participant may construct his “dream team” 310, by registering their owned stocks as a team, optionally subject to meeting pre-defined rules for a specific competition or a specific sport. For example, the dream team 310 may be a soccer team having eleven active players 351-361 and four substitute players 362-365, whereas the eleven active players are required to include one goalkeeper, three strikers, three midfielders, and four defenders. A participant that owns stocks corresponding to less than eleven soccer players, may not be allowed to construct his soccer dream team. Furthermore, a participant that owns stocks corresponding to twenty soccer players, none of which is a goalkeeper, may not be allowed to construct his soccer dream team. Optionally, a graphical representation 320 of the dream team may be presented to assist the user in constructing the dream team or manning the required team positions. For example, graphical elements in the graphical representation 320 may indicate a required position available for manning by a sports player. In some embodiments, the participants may be able to, or may be required to, name or other identify or register his dream team, for example, by creating a team name 330 or other unique identifier associated with his dream team.

In some embodiments, a tabbed interface may be used in conjunction with court or field views; for example, a “real mode” tab 321 and a “sketch mode” tab 322 may be used in conjunction with the graphical representation 320. In some embodiments, an interactive interface may be used in conjunction with the graphical representation 320 or with components thereof. For example, as indicated by arrow 325, clicking or selecting or hovering over an item in the graphical representation 320 may perform a zoom-in to provide contextual information 326, e.g., indicating the player's name, the price of its stock, the change of price, buttons to initiate a buy or a sell of its stock, or other information or functions. In some embodiments, other interactive features may be used, for example, sliding menus, collapsible information items, expandable information items, “balloons” or “bubbles” of information, pop-up windows, super-imposed layers or windows of information, or the like.

Dream teams constructed by different participants may than virtually compete, e.g., for prizes, on a weekly basis, monthly basis, seasonal basis, or other time frame. The points for that competition may be calculated based on the real performance of the players; for example: a striker who scores a goal earns three points to his dream team score. The team manager whose team collects the maximum points in the defined time frame (or who meets other criteria) is the winner and is entitles to receive the prize.

In some embodiments, there need not necessarily be a direct connection between the score of the points in the competition between dream teams, and the stocks' values and prices. For example, a stock corresponding to a player whose performance is spectacular may not necessarily rise automatically in price, but rather, its price may increase or decrease based on supply and demand market forces, based on speculations, or the like.

In some embodiments, a participant may act as a league commissioner and may create and manage a private league, define rules and properties such as prizes, entry fees, whether the competition is public (e.g., open to the general public of participants) or private (e.g., by invitation only), the structure of the competition (e.g., rounds, full season, playoffs, head to head), or other properties. Other participants may compete with their designated dream teams on the competition defined by the league commissioner, after purchasing stocks (corresponding to their dream team players) on the stock market and paying the entry fee and relevant commissions attached.

In some embodiments, a commissioner may start a new challenge (e.g., according to pre-defined presets) substantially anytime and/or substantially without limitations, such that substantially every user may be able to join the challenge, or that users may join according to the commissioner's customized rules (e.g., in case the commissioner invites the participants in advance), and/or based on available “spots” in the new challenge. A new challenge created by a commissioner may have a date and time indicating “end of sign up”, at which the system will check whether or not the minimal number of participants (that should have registered, and paid the entry fee for the challenge until that time) that has been set for the challenge is reached. From that point, additional users may not be able to sign up for the challenge anymore, and activities that are required to be performed before the beginning of the challenge are executed, for example, draft, spreading the participants into groups or divisions, generating a schedule or a game plan, or the like. In contrast, if the minimal number of participants is not reached by the “end of sign up” date and time, then the challenge may be canceled (e.g., automatically by the system) and the entry fees may be paid back to the relevant users' credit or balance. In challenges that are created based on pre-defined presets, the system may allow to automatically transfer participants between similar or substantially identical challenges; for example, to automatically transfer participants who registered for a first challenge, which did not reach its minimal number of participants, to a second (similar or substantially identical) challenge which still has available spots.

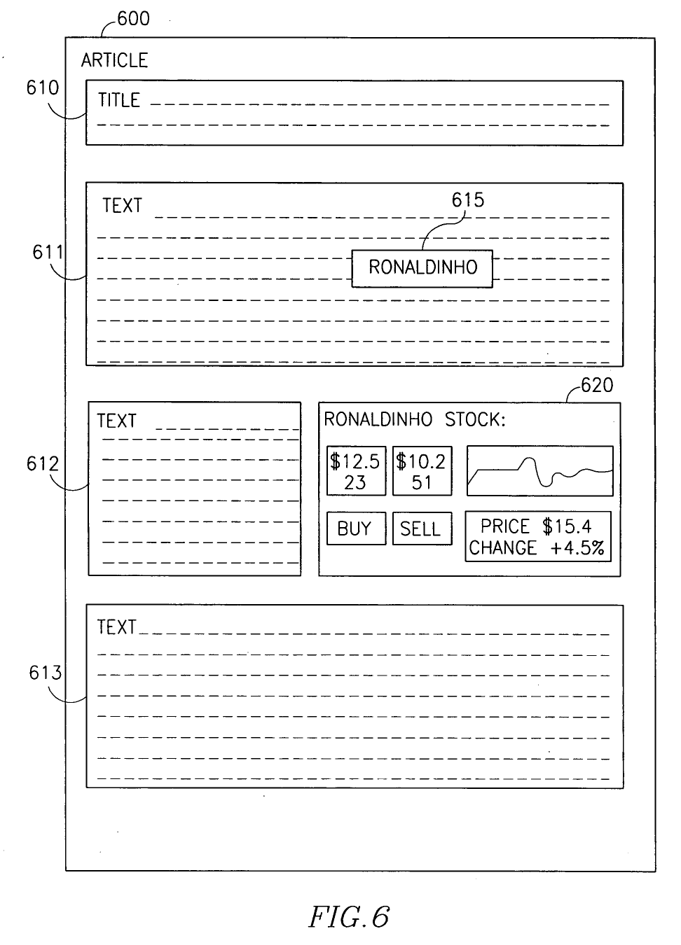

In some embodiments, a participant may act as an analyst and may provide content, may analyze and add content referring to the market on sports and financial matters, or the like. In this context, some embodiments may utilize, for example, manual or automatic creation of “tags” or keywords associated with a participant-created content; embedding of interactive content in conjunction with participant-created content, for example, similar to the embedding discussed with reference to FIG. 6; hierarchy or meaningful links or direct URLs for search engine optimization (SEO); shortcuts or “permalinks” associated with various participant-created content; or the like.

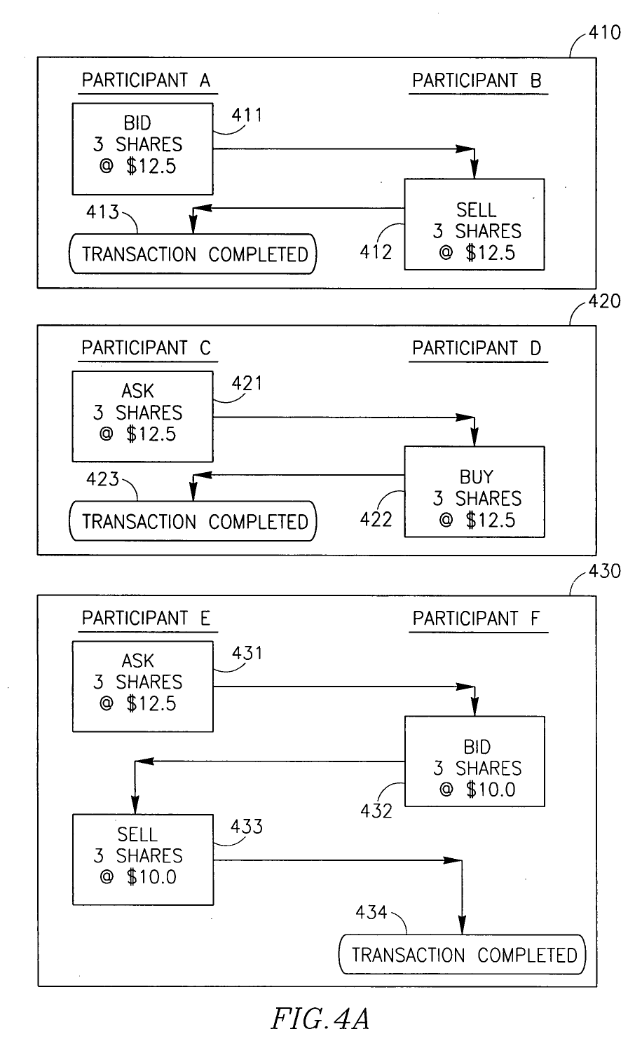

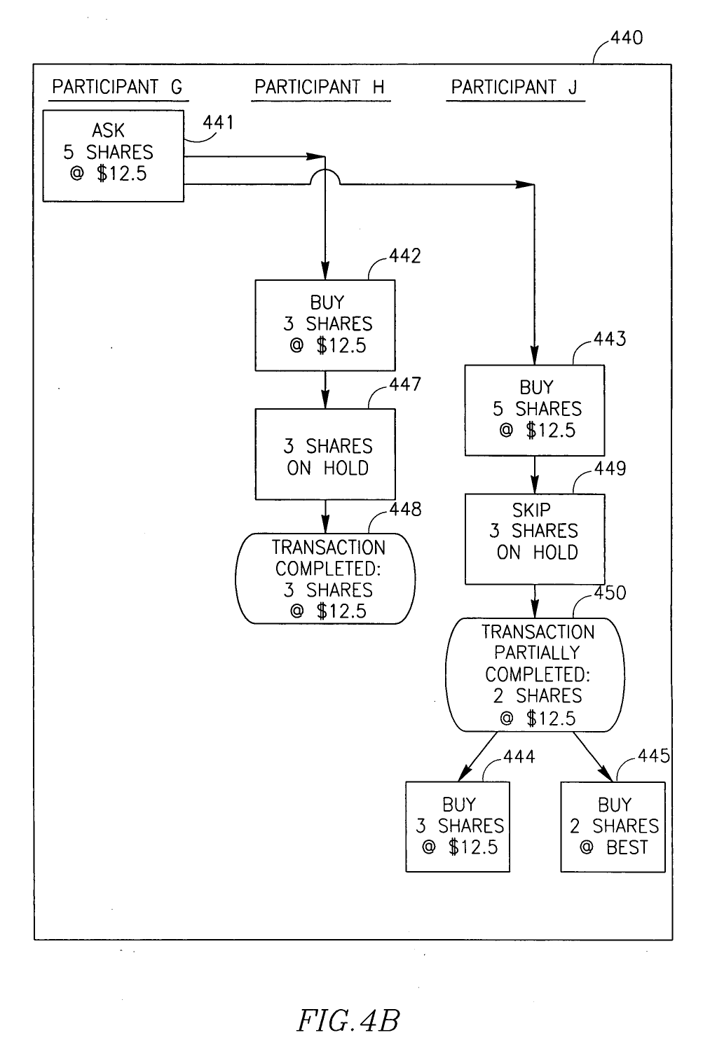

FIGS. 4A and 4B schematically illustrate multiple demonstrative processes 410, 420, 430 and 440 of stock trading in accordance with some demonstrative embodiments of the invention.

According to a first process 410, Participant A desires to buy three shares of stock corresponding to Player 1. Participant A may look up this stock on the stock market, but may not find any available shares of this stock offered for sale by other participants. Participant A may place a “bid” order 411 for that stock, indicating the number of shares that he desires to buy and the price per share that he desires to pay, and optionally indicating an expiration date/time. The system may calculate the total price of his bids together with the commissions attached and deduct this total sum from his credit or “balance” and put that amount on “hold” or pending status. Participant B may own three or more shares of the stock that Participant A desires to buy; and Participant B may agree to sell to Participant A three shares of that stock at the bid price, by placing a “sell” order 412, thereby completing the transaction 413. In some embodiments, upon entering the “bid” order 411 by Participant A, the system may create a “sell option” and may send messages to holders of that stock, alerting them that a “bid” order 411 is placed with regard to stocks that they own. The “bid” order 411 (and the corresponding “sell option”) may expire, for example, upon fulfillment of the “bid” order 411 or upon expiration of the time period associated therewith.

According to a second process 420, Participant C may own ten shares of stock corresponding to Player 2, and desires to sell two of those shares. Participant C may look up this stock on the stock market, but may not find any available bids open by other participants for this stock. Participant C may place an “ask” order 421 for that stock, indicating the number of shares that he desires to sell and the price per share that he desires to receive, and optionally indicating an expiration date/time. Participant D may look up the stock on the stock market, may see the “ask” order 421 placed by Participant C, and may accept the “ask” order 421 by placing a “buy” order 422, thereby completing the transaction 423.

According to a third process 430, Participants E and F may exchange multiple communication messages until they reach an agreement and a transaction is executed. For example, Participant E may place an “ask” order 431, offering to sell three shares at a price of 12.5 dollars per shares. In response, Participant F may place a “bid” order 432, offering to buy the three shares, but at a lower price of ten dollars per share. In response, Participant E may accept the “bid” order 432 by placing a “sell” order 433 to sell his three shares at the price of ten dollars per share, thereby completing the transaction 434.

According to a fourth process 440, Participant G may place an “ask” order 441, offering to sell five shares at a price of 12.5 dollars per share. In response, Participant H may place a partial “buy” order 442 to buy three of the five shares at the asked price of 12.5 dollars per share. Optionally, the three shares may temporarily be placed on hold 447, until completion of this portion of the transaction 448. Participant J may place a full “buy” order 443, attempting to buy the five shares offered by Participant G at the asked price of 12.5 dollars per share. However, three shares are already placed on hold and are skipped 449, due to the partial “buy” order 442 already placed by Participant H, only two shares may be purchased by Participant J at this time 450 (e.g., if Participant J did not attach to his “buy” order 443 an “all or none” extension or a “fill or kill” extension, indicating that he wishes to buy only the entire amount of five shares and does not wish to buy a partial amount). Optionally, Participant J may proceed (e.g., manually, or may instruct the system in advance to proceed automatically) to place a “bid” order 444 for three shares at a price of 12.5 per share, or to place a “buy” order 445 to buy three shares at the next available price.

Other trading processes and trading tools may be used. For example, bid orders, ask orders, buy actions and/or sell actions may be performed manually or automatically, e.g., using limit prices, “stop loss” mechanisms, expiration mechanisms, triggered-trading mechanisms, or the like.

In some embodiments, the gaming system may use pre-defined rules to determine the winner(s) in a competition having dream teams that are substantially identical. For example, a first participant may purchase shares of stocks corresponding to soccer players, may construct a dream team, may register his dream team's name, and may sign up (and optionally pay an entry fee) to participate in a particular competition. A second participant may later construct another dream team having substantially identical players. If the dream team wins the competition, then the first participant (and not the second participant) may be declared the winner and may be entitled to the prize, for example, based on the fact that the first participant was the first to construct and register his dream team. Other rules may apply, for example, to modification of dream team players, for example, due to trading stocks and/or re-registering a modified dream team; in such cases, the modifications may be effective prospectively and not retroactively. In some embodiments, for example, the “moneyball rate” may be used to determine the winner(s) in a competition having dream teams that are substantially identical, e.g., instead of using time priority criteria or before using time priority criteria. In some embodiments, the moneyball rate may be used as a first-priority parameter for determining how to handle a tie-breaker; if not solved, pre-defined single statistical categories may be used as a second-priority for handling a tie breaker; if still not solved, the a third-priority parameter may be the time in which the participant registered his fantasy team. Other priorities may be set or used.

The gaming system may utilize a scoring scheme for each sports field, to convert various measurable properties of real-life sporting actions into matching fantasy points. For example, the following table, denoted Table 3, demonstrates conversion between real-life performance of soccer players and fantasy points:

TABLE 3

| | Goal | Goal | Goal | Penalty | Yellow | Winning | Losing | Draw |
|---|---|---|---|---|---|---|---|---|
| | Scoring | Assisting | Received | Missed | Card | Team | Team | Team |
| Striker | +3 | +1 | −1 | −5 | −1 | +3 | −1 | +1 |
| Midfielder | +4 | +3 | −1 | −4 | −1 | +3 | −1 | +1 |
| Defender | +5 | +4 | −2 | −3 | −1 | +3 | −1 | +1 |
| Goalkeeper | +6 | 0 | −3 | −2 | −1 | +3 | −1 | +1 |

In some embodiments, more-detailed tables may be used, or less-detailed tables may be used. For example, the following table, denoted Table 4, demonstrates conversion between real-life performance of soccer players and fantasy points:

TABLE 4

| | Striker | Mid-fielder | Defender | Goalkeeper |
|---|---|---|---|---|
| Goal scored | +5 | +7 | +9 | 0 |
| Assist | +5 | +5 | +9 | 0 |
| Goal received | 0 | 0 | −1 | −11 |

In some embodiments, a competition may be open for participation only by participants that registered their dream teams, for example, subsequent to purchasing shares of stock corresponding to the relevant players. For example, real-life performance of the players may be converted into fantasy points (e.g., using a scoring scheme similar to Table 3 or Table 4), and the manager who registered the dream team that accumulated the highest fantasy score is declared winner; optionally, second and third runner-ups may be declared, or other rules may be used. In some embodiments, participants are required to register their dream teams for the competition (and to purchase and own stocks of relevant players) until a specific published date and time, before the first game of the round begins and/or before the last game of the round begins.

In other embodiments, users may participate in a competition even without registering a complete dream team, based on the ownership of stocks that correspond to relevant players. For example, a first criterion may calculate the real performances points of each stock divided by its assessed value at time of purchase. For example, a stock corresponding to Player 1 is purchased at a price of ten dollars per share, and the real-life performance of Player 1 subsequent to the time of purchase is equivalent to five fantasy points; accordingly, a ratio of 0.5 is calculated as the first criterion. A second criterion may, for example, calculate the stock's financial performance during the same time period. For example, if the stock price increased from ten dollars to thirteen dollars, then a positive ratio of 1.3 is calculated as the second criterion. In some embodiments, winner(s) may be declared based on the first criterion, based on the second criterion, based on an average of the first and second criteria, based on a function taking into account the first criterion and/or the second criterion, or based on other suitable calculations.

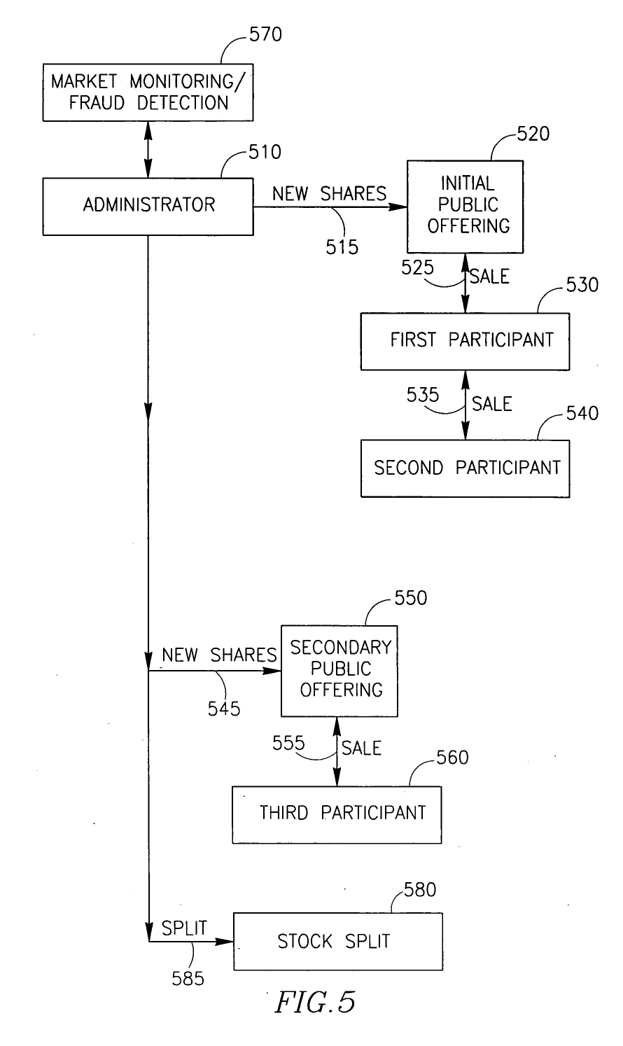

FIG. 5 schematically illustrates registration and trading of stocks corresponding to sports players in accordance with some demonstrative embodiments of the invention. An administrator 510 of the gaming system may register for sale (arrow 515) new shares (e.g., five hundred new shares) of stock corresponding to a particular sports player, e.g., Player 18. The new shares may be offered for sale by the gaming system, for example, using an initial public offering (IPO) 520. A first participant 530 may purchase (arrow 525), for example, twenty shares at the IPO 520, e.g., at a price of two dollars per share. Subsequently, a second participant 540 may purchase (arrow 535) from the first participant one or more of the shares of stock owned by the first participant.

Additionally or alternatively, the gaming system may determine (e.g., automatically, based on market analysis) that the demand for the stock of Player 18 is significantly greater than the supply for that stock. Accordingly, the administrator 510 may register for sale (arrow 545) new shares (e.g., three hundred new shares) of stock corresponding to Player 18. The new shares may be offered for sale by the gaming system, for example, using a secondary public offering 550. A third participant 560 may purchase (arrow 555), for example, seven shares at the secondary public offering 550, e.g., at a price of three dollars per share.

In some embodiments, the administrator 510 may utilize a market monitoring and fraud detection module 570. In some embodiments, as indicated by arrow 585, the administrator 510 may perform a split 580 (or a reverse split), thereby changing the number of shares in the market and the price-per-share after the split 580.

FIG. 6 schematically illustrates interactive embedded content in accordance with some demonstrative embodiments of the invention. A news article 600 may be published using an interactive medium, for example, online, in a web-site, using interactive television, or the like. The article 600 may include a title 610 and one or more story portions 611-613. The article 600 may include the name 615 of a sports player, for example, “Ronaldinho”, whose corresponding stock is traded on the stock exchange market. The system that distributes or presents the article 600 may perform a keyword search, for example, searching for sports players names 615 that may be mentioned in the article 600, and may include in the article 600 or in proximity to the article 600 an additional content portion, e.g., an embedded content portion 620. The embedded content portion 620 may include, for example, information regarding the stock corresponding to the sports player whose name (e.g., “Ronaldinho”) was identified in the article 600. The information may include, for example, a “stock quote” of the latest trading price of that stock, a current “bid” price, a current “ask” price”, a current “bid” number of shares, a current “ask” number of shares, a current change in stock price in monetary values, a current change in stock price in percentage, an arrow indicating increase or decrease in the stock price or indicating a trend, or the like. Optionally, the embedded content portion 620 may include buttons, links, hyperlinks, shortcuts or other interface to allow a user to actively use the embedded content portion 620 in order to retrieve more information, to trade the stock of that sports player, or the like.

Some embodiments may provide a fantasy sports exchange, namely, a virtual exchange where users can trade virtual “stocks” corresponding to sports players. Optionally, supply and demand forces may be based on the fantasy sports contests. In some embodiments, the gaming system may present a home-page or a front-page, for example, a home-page for each sports field or each league showing highlights (e.g., markets and challenges), news and updates, scores, schedules, users content, or the like. A community forum or area or “blog” may allow users to share their opinions, analysis, comments, posts and thoughts. A “market” area may be used for virtual exchange of stocks corresponding to stock players, whereas a “challenges” area may be used for fantasy sports contests.

In the market area, users perform trading activities (e.g., buy and sell) in the virtual exchange. The demand in the market may be based on the demand of fantasy teams managers to assign players in their team, and/or on other factors (e.g., speculations). In some embodiments, it is possible to trade stocks without the need to be a fantasy team manager, such that substantially any user in the system may purchase and sell stocks. The goal of such users may be to gain real profit from the portfolio according to the principle of buying at a low price and selling at a higher price.

In some embodiments, a fantasy sports challenge may be a contest where each fantasy team manager may form a fantasy team according to a defined formation, and optionally subject to one or more other requirements or pre-defined rules, for example, a salary cap (e.g., budget) or draft picks. In some embodiments, the fantasy team may include players that in order to recruit each of them, the team manager is required to own at least one share of stock attached to the specific player. Purchasing the players (stocks) may be performed through the stock exchange (e.g., the players marketplace) using bid/ask activities. For example, the user may buy the stocks/players from the market using his real-life money (e.g., deducted from his credit balance which is set after depositing real money into his online account) and according to his “bid” order or the current “ask” order (if he chooses to accept it). After purchasing the stocks/players, the user registers his fantasy team to the challenge and submits it to compete in the next round. Each player in the fantasy team accumulates fantasy points (scoring), which is calculated according to his real-life performance (e.g., based on his actions and on statistics), and accordingly the total scoring of the team is calculated. The team who accumulated the highest total of fantasy points among the users grants its owner or manager the prize.

In some embodiments, several categories may be defined for each sports field for the fantasy team formation and the number of stocks that are required to be included in the team. For example, in soccer it may be required to own at least 11 different stocks, divided into positions: goal keeper, striker, mid-fielder, and defender; and a possible formation may be: one goal keeper, two strikers, four defenders and three mid-fielders. In some embodiments, the user may be able to buy stocks without any limitation, although the team is created according to the allowed formation(s) of the specific sport. In order to assign each player to the team, the obligation is to assign at least one stock of the player.

In some embodiments, the “market” area and the “challenges” area may be two parallel tracks that influent each other, two separated tracks, or inter-connected tracks. In some embodiments, scoring in the challenges (fantasy points) does not change the stock's price which is determined by market forces. In some embodiments, users need not pre-select to participate only in the market area or only in the challenges.

The market area may be operated in accordance with pre-defined rules of stock trading, for example: There may be, or there may not be, a limit on the number of stocks that a user can buy; the user may place “ask” or “bid” orders with price limits or without price limits; the system may perform a stock split (e.g., cutting the price by two and doubling the amount of stocks), a reverse-split, secondary or additional public offerings (e.g., to insert more stocks to the market); a user may possibly own a limited or an unlimited percentage of the shares of a given stock; a user may not trade stock with himself; if the user sells a stock which he owns, and he has more stocks of the same player, the system may choose automatically the stocks with the highest fantasy value to sell; or other rules. In some embodiments, for example, when a stock is purchased, the fantasy value of its player may be “frozen” and calculated as his virtual salary. As long as it remains in the user's portfolio this value does not change, however when it returns to the market (e.g., due to Sell), its fantasy value is updated immediately and automatically to the current fantasy value of the stock in the market.

The market area may allow various trading activities, for example: buy available stocks according to the ask/bid offers; sell available stocks according to the ask/bid offers; bid order for buying stocks in another price which is currently not offered; ask order for buying stocks in another price which is currently not offered; automations, e.g., price limit, stop loss, triggered trading, conditioned trading; expiration parameters, e.g., fill or kill, all or none, limit or cancel, time frame; watch-list functions and alert functions to track the market performance of selected stocks; or the like. In some embodiments, automation functions may be presented in an expanded view of the player's ticket, whereas expiration parameters may be attached to the minimal view.

In some embodiments, a user may view his portfolio using a “my portfolio” screen or object, for example, showing real-time (or slightly delayed) tracking of the market for showing the real profit or loss. The portfolio table may be automatically filtered or sorted by the sport that the user is in, and the particular league he is in. When a stock is clicked or otherwise selected, the system will pop up a side-bar from the “field”, that will show the name of each fantasy team that this stock is assigned. If the user chooses to sell a stock that is assigned in a team, the system will alert the user. If there are more than one stock of the same player, and the user chooses to sell one, the system will automatically keep the one with the lowest fantasy value. If there are more than one stock of the same player, the table in the collapsed mode will show the number of stocks of the player, the average price, and the limit (high and low); whereas the expanded view may show each stock in a different row. As a default, the system may automatically set the fantasy value of each player in all of the fantasy teams according to the lowest fantasy value available.

In some embodiments, each real-life team and league (and other groups that the administrator may select) may be associated with an “index”. For example, a real-life team's Index includes all the players that play in this team, and the sum of the all prices of individual players may be used to yield the statistics of the team's index. In some embodiments, a team's index may include weighted components, such that a weight attributed to a first (e.g., dominant) player may be greater that a weight attributed to a second (e.g., less-dominant) player. In some embodiments, upon clicking on the team's name in the index table, the team's card is opened.

In some embodiments, a personalized watch-list may be used to show stocks-of-interest that are watched or tracked by a user. The list may be shows similarly to a portfolio, however since the user does not necessarily own all the stocks on his watch-list he may not be able to sell all of them (but may be able to view information and buy the stocks). In some embodiments, an alerts mechanism may be used to send alert notifications to users, for example, when a stock price increases or decreases, when a volume of stock is traded, or based on other conditions. Alerts may be sent, for example, using system messages, email, SMS, MMS, Instant Messaging (IM), beepers, pagers, voice messages, or other suitable methods.

Some embodiments may utilize a reference point of trade or a time of trading scheme. In some embodiments, the administrator may set the starting time of trading, which may be also the ending time (e.g., a 24-hour cycle of trading), and price changes may be calculated referring to this “closing” time. Some embodiments may provide online trading 24-hours per day and 7-days per week; other embodiments may pre-define trading days and/or trading hours. In some embodiments, the “closing” price of a stock at the “closing” of day of trade may be calculated using one or more methods, for example, based on the average of a pre-defined number of last trades, optionally utilizing a weighted average that takes into account the quantity of shares in each of the last trades, or the like.

Some embodiments may provide graphical representations (e.g., graphs, charts, pie charts, bar charts, or the like) corresponding to stock performance or statistical information. Some graphical information may optionally be associated with real-life performance, with changes in time frames, with fantasy points scoring, or the like.

In some embodiments, a user may define substitute players or bench players in his team, for example, up to one substitute player per position. A substitution may be executed automatically if a pre-defined condition is met, for example, if a player with the same position in the roster of the fantasy team does not play in real-life at all during the specific round.

In some embodiments, a new visitor to the gaming system may be able to browse the current challenges and to create a fantasy team (e.g., full or partial) in a “sketch mode”. If the user is already registered, he may be able to save the sketch that he created. Only after depositing money into his account, and payment for the “shopping cart” and the entry fee, the user may register his team for actual participation in the challenges. In some embodiments, the user may request to assemble a random or pseudo-random team; may utilize a “buy all” button or link in order to quickly perform multiple purchases (and/or multiple bids); or the like. In some embodiments the user may utilize calculator tools to test or simulate fantasy points accumulated based on predictions or assumptions; for example, a first calculator in which the system forecasts the fantasy points based on history performance, e.g., average fantasy points per game; a second calculator in which the system forecasts the fantasy points based on average statistics per category; edit-able calculators in which the user may modify parameters or forecasts; calculators to predict accumulation or distribution of fantasy points over multiple players or over one or more fantasy teams; or other suitable tools. The system may calculate the level of accuracy between the forecast or prediction and the actual scoring.

In some embodiments, challenges may be divided into two main types: challenges that are set by the system (Public and Sponsored), and challenges that are set by the users (Private). Challenges may be searched, presented and/or sorted based on various parameters, for example, field of sports, type of challenge, length of challenge period, number of rounds, time remaining for registration to the challenge, or the like. For example, a quick-link may show challenges whose registration is about to close soon. Some embodiments may allow filtering of challenges created by users based on one or more criteria, joining together challenges based on a common preset or template allowing pre-defined customized challenges, or the like.

In some embodiments, a public challenge is set by the system. For example, several users (e.g., 8 or 10 or 12) are automatically collected into a group. In each group, a Head to Head challenge may be set. The system may set a schedule for the challenge, such that in each round each user will play against another user within their group. The winner from each game between the pairs will achieve points, and accordingly the group tale is updated. In some embodiments, a “tournament” style competition may be performed within each group, such that each fantasy team in the group plays against each other fantasy team in the group. Optionally, in each round, the best fantasy team out of all of the groups may win an additional prize (e.g., “best of the round”). After a pre-defined number of rounds in the season, there are chosen N first places from each group, and a new schedule is set. In each round the winner of each pair will meet the winner of the other pair, until there is one finalist who is the winner (a “knock-out” or “playoff” type competition). In some embodiments, for each user, the system calculates the average of the fantasy points gained on the best N rounds in the season or all the rounds. In some embodiments, if two or more fantasy teams have the same number of fantasy points, the better team may be the team which is more cost-effective, e.g., the team with lower total of fantasy value (salary); other suitable criteria may be used to determine a winner team or a better team in similar cases.

In the system's challenges there may be the ability to join to the Head-to-Head tournament substantially at any time, for example, by creating substantially unlimited number of groups and divisions for any given round. However, with regard to each group or division, there may not be allowed a situation in which there are participants who joined the challenge on different rounds. The system may predefine the round number and its date, such that from that time and onward users may not be able to join the Head-to-Head tournament anymore for the current season. The system may calculate an average of fantasy points per round and/or table points per round, for example, in order to determine who continues to the next stage (the playoffs), in order to compare the performance of the participants who joined the challenge on different rounds, when the predefined time (round) arrives. The system challenge may include an open tournament for each round and/or other time frames that may entitle a prize for the owner of the best fantasy team. This tournament may be opened each round and may not have registration limits. The system may further operate draft-mode challenges that may be opened on each round for a variety of period of times (for example, until the end of the season, or for a four-rounds challenge, or the like).

In some embodiments, team formation may be subject to requirements. For example, in the challenges a full team is required according to the allowed formation(s), without exceeding the limit of the number of players from the same (real) team that can be assigned in the fantasy team, and optionally subject to a salary cap limit. In case of other challenges with different formations settings, the system may calculate the salary cap limit accordingly, for example, by retrieving the current average fantasy value of each position in the market.

Some embodiments may require conditions for eligibility of fantasy team to compete in each round and to score points, for example, a requirement that the team is full with players that played or started to play (automatically) or a full team that is submitted manually. In some embodiments, meeting a condition may be irreversible for at least the round in progress or the current round. In some embodiments, it is not required to wait for an exact or specific time, but rather, as long as that a player is assigned or substituted before he started to play in real-life, it may be possible to edit or modify his spot in the team.

In some embodiments, all of the team's squad is required to be fully registered, e.g., such that the proper stocks are owned by the team manager. This requirement may be met manually (e.g., by pushing a “submit” button) or automatically (e.g., after all of the players started to play in the round). In some embodiments, stocks of players that play in a round-in-progress may be “frozen” and may not be sold during the round-in-progress; in other embodiments, a user may sell stocks of players even if he registered those players for future rounds of a challenge. For example, in some embodiments, a user may build a full fantasy team before the beginning of the round and push the “submit” button; the fantasy team is now permanent for that round, and the user may sell the stocks and prepare for the next round.

In some embodiments, in-game trading may be possible. For example, the user starts with constructing a partial fantasy team, e.g., for a round of five days in a challenge that has eight players formation. On the first day, the user does not buy any stocks. On the second day, the user buys stocks of two players that are about to play in the evening, and also buys stock of a third player who is about to play tomorrow. On the third day, it is not possible to change the spots of the players that played yesterday, and it is not possible to sell them. However, the third player which is about to play today may be sold and may be substituted for two players that are going to play today. On the fourth day, the user buys four players that are going to play today. Although the round is going to last until the fifth day, there is no need to wait, as the fantasy team is full. In some embodiments, it is possible to push the “submit” button in every single moment during the round as long as all of the conditions described before are met.

In some embodiments, once a game starts in real-life, all of the players that are attached to it are “locked” or “frozen” for the rest of the round. During the round the players are shown with their accumulated points. Other players who did not start their games can be edited, sold or substituted, and all of the available players are also presented in the table. After the end of the round, a new editable sketch of the team may be opened for the preparation for the upcoming round.

Some embodiments may calculate and show countdown information and/or status information. For example, “next match” information with a reverse time-counter to the beginning of a match that is expected to cause the next “freezing” of a player owned by a participant, may be presented to that participant. Similar information may be presented with regard to individual players and/or the entire fantasy team of a participant, for example, a round's countdown until the end of theoretical time to register a team for the current round, a status icon that indicates whether or not the team is fully compatible with all the requirements (formation, salary cap, etc.), or other information.

Some embodiments may utilize tie-breaking algorithms to declare winners, for example, if there are identical fantasy teams. For example, a tie-breaker algorithm may utilize the rate between the fantasy points (scored) and the fantasy value (cost). If the rate is also identical, a second tie-breaker may be the time of registration of the team, such that the earlier registrant wins and/or by comparison of pre-defined single statistical categories. In some embodiments, upon registration of a fantasy team, the system may alert the participant that he registers a fantasy team identical to another previous-registered fantasy team.

In some embodiments, a participant may register a player's stock in multiple fantasy teams, e.g., in a single challenge and/or in multiple challenges. In some embodiments, automatically or upon manual request, the player's stock with the lowest salary (fantasy value) is assigned for a fantasy team being constructed. In some embodiments, a participant may not register more than one fantasy team per challenge. In other embodiments, a participant may register multiple fantasy teams per challenge.

In some embodiments, a “sketch mode” may be used to create a fantasy team. For example, the user can plan his team on a visual “court” or “field”, by placing players that are bought and exist in the portfolio or players that were not yet bought (in the shopping cart). The roster may be viewed either visually or in tabular mode. Sketch mode planning may be saved and re-loaded for further editing. Some embodiments may allow to make multiple purchases substantially simultaneously, based on the “shopping cart” which is the sketch plan of the team. This action may perform “buy” deals in the market substantially simultaneously according to the current market prices and/or place bids orders.

In some embodiments, a user interface (UI) or a graphic user interface (GUI) may be used to facilitate the participant's ability to navigate in the gaming system and/or to facilitate entry of commands and/or to facilitate presentation of output. For example, zoom-in and zoom-out features may be used to expand information or to narrow information; updating or modification of content may be performed, optionally without page reloading or without page refreshment; a tabbed interface may be used to allow the user to switch between modes (e.g., between “real mode” and “sketch mode” and vice versa); a windowed interface may be used to present layers of information, optionally using pop-up windows or super-imposed layers; animation or other visual effects to emphasize a screen element; audible alerts, audible messages and audible notifications; audio/video content (e.g., describing each sports player) and audio/video help content; drag-and-drop interface to facilitate selection or trades; sorting and/or filtering tables without page reloading or without page refreshment; switching among active teams and/or challenges; navigating between market and challenges screens without page reloading or without page refreshment; and other suitable elements or effects.

Some embodiments may construct a random or pseudo-random team, automatically or based on a user request. For example, the system may build or suggest a partial or full fantasy team for a participant based on available stocks in the market in order to assist the participant on planning and creating his team.

In some embodiments, a watch-list of players (e.g., for a possible fantasy team) may not require registration or payment, but may not allow to participate in challenges. The system may virtually track the watch-list fantasy team's performance as if it was active in the challenge.

Some embodiments may present the user with various scoring calculators, to help the user to calculate the potential fantasy points to be accumulated by his planned fantasy team according to his predictions. Some embodiments may show, for example, next to the predictions, the actual scoring and may calculate the level of accuracy of the predictions.

Some embodiments may allow head-to-head (H2H) planning. For example, a first participant may view a fantasy team (under construction, or finalized) of a second participant, separately or in comparison (e.g., side by side) to the first participant's fantasy team. In some embodiments, when a “draft mode” challenge is active, the system may allow users to perform trades.

Some embodiments may present a main “Challenges” screen, showing a table with sorting capabilities, searching capabilities and/or browsing capabilities, in order to view, enter or compare one or more public or private challenges. Once the user selects a challenge, the front page of the challenge is presented, showing editor or commissioners posts, rules of challenge, countdown until the end of registration, and other information; and optionally allowing the user to open a sketch mode in the challenge without obligation, but without actually participating in the challenge. In order to participate in the challenge, the user may be required to pay the entry fee, use a coupon, or otherwise make monetary arrangements, and then the user may be assigned into the proper group of users.

Similar capabilities may be associated with the main “Market” screen, for example, showing a table with sorting capabilities, searching capabilities, filtering capabilities and browsing capabilities; e.g., filter strikers only, search for a specific player according to free-text query, perform a query based on a combination of categories such as “show all the goalkeepers that are available for less than $10, and scored more than 25 fantasy points”, or the like.

Some embodiments may calculate and utilize a fantasy value. For example, each player may have a price (namely, the current stock price in the exchange market, denoted in real-life monetary value) and also a fantasy value, which is not real-life money value, and is determined by the gaming system. In some embodiments, the user may be required to form a fantasy team which does not exceed a defined total amount of fantasy value (namely, salary or budget). Some embodiments may utilize a “money ball” rate or “cost-effective” factor, corresponding to the rate between the fantasy points and the fantasy value.

In some embodiments, a user can create a private challenge, in which a group of users join to form a competition and they are all competing to win the league's prize.

In some embodiments, the system may create automatically for each user his own personal space where people can view his personal details (the ones that he allowed the system to show, such as his age, location, favorite teams or players etc.), and optionally his performance in the game, for example, the size of his portfolio, profits in percentage and monetary amounts, and status of his fantasy teams (winnings, trophies, rank, etc.). Each user may edit his personal space, may write posts in it (blog), may receive talk-backs, rates of readers, and if the rates of his posts are high those posts may be shown in the home page.

Some embodiments may utilize users' blogs, articles, and tags. A user may write a new post from a “My Blog” screen (e.g., inside a “My Space” section), and then may determine the relevant tags and attach them to the desired players. The user may also write a new post through the player's card and may attach the post to be presented in the player's card. When the user clicks on the link in the player's card, he is brought to the My Blog screen where the tags and the subject are already selected. Posts may be ranked by users (like, do not like, interesting, important, etc.).

In some embodiments, each challenge may have a forum for group discussions, and each division group may have its own forum as well. Other forums may be used (e.g., for technical assistance, for customer service, or the like).

In some embodiments, the “My Space” section may be presented after the user logs-in into the system, and may show personalized information to that user, for example: “My Balance”, assets pie, portfolio's calculations, rank and scoring, access for each of the user's portfolios, best and worst performance stocks, my watch list, my challenges, news regarding players, news regarding my players, my messages, propositions regarding my participation in private challenges, special offers, relevant articles, my blog (with ability to edit content, personal space), my profile (with ability to edit personal details and personal customization), my wallets (with ability to add or edit payment options), my friends (users for keeping in touch with), and other information.

The system may be multilingual, and/or may fully support a multi-language interface. The user may choose his preferred language, but may actually browse and perform activities in the same unified system (Market and Challenges) regardless of which language he chose. In some embodiments, optionally, the only different part may be the community section that will only display the content written in the selected language.

Other features that may be presented include, for example, a help center, customer support center, a live help chat, a help forum, a ticker (e.g., showing real time market data, tabs for changing the data, different markets, news, my portfolio, my watch-list, or the like), search interface (e.g., free text search for finding players, sorting the tables by statistics, or the like), player cards or participants cards (e.g., presenting all the participant information, statistics, graphs, relevant news, users posts, external links, with the ability of minimizing and maximizing the view of the players' cards), system messages (e.g., each stock in the participant card may have an icon showing if the system has relevant messages regarding its player), or the like.

Some embodiments may utilize search engine optimization hierarchy, for example, using direct links or shortcuts straight to the player's card, wherein the link name or the shortcut may include the player's name, and may provide a direct link to the information, statistics and market activities of the specific player. In some embodiments, hierarchy may be performed for teams, challenges, users, blog posts, or other elements.

In some embodiments, real money stock exchange may be powered by competition among two or more managers of a “dream team”. A team manager may buy stocks corresponding to players from the stock market. However, either the stocks exchange activity or the competitions are operated independently, on parallel channels. By separating these courses, each user can choose whether he would like to trade player's stocks, in order to make profits from his portfolio, or to compete on the dream team's competition in order to win the prize, or to participate on both channels.

Some embodiments may provide an organized electronic market for trading shares in real-money. Some embodiments may enforce a healthy market activity by keeping a margin between supply-demand forces, while supporting the growth of the market. Some embodiments may eliminate or detect frauds attempts, or attempts to abuse the system in order to make illegal profits or unfair profits. For example, back office management software may monitor the activity of the market and the users, and may identify symptoms for fraud attempts, problems with the margin between demand and supply on the market, etc. The back office may be the platform for fixing those problems, automatically and/or manually by the system administrators.

Some embodiments create an online multiplayer game based on the internet which can convert any sports league and its players into real-money stocks exchange market, driven by bid/ask calls and actions, by letting the participants set their desired prices directly, while keeping proper, well-balanced demand-and-supply rate together with support for substantially infinite increase of participants.

Although embodiments of the invention are not limited in this regard, the term “stock” as used herein may include, for example, stock corresponding to a real-life sports player. In some embodiments, at any given time, a particular amount of shares of stocks of each player may be available on the virtual market. For example, on a first day at a first time, 500 shares of stocks of Player 4 may be available for trading, and 620 shares of stocks of Player 7 may be available for trading; whereas on a second day (or at a second time), 550 shares of stocks of Player 4 may be available for trading, 620 shares of stocks of Player 7 may be available for trading, and 300 shares of Player 9 may be available for trading. A stock may be associated with a player's name, age, weight, height, statistical information, past performance information, team, or other information.

Although embodiments of the invention are not limited in this regard, the term “stock price” as used herein may include, a most recent price at which the stock was traded.

Although embodiments of the invention are not limited in this regard, the term “price change” as used herein may include, for example, a change (e.g., in dollars, in percentage, a direction or trend, or the like) between a price of a stock at the most recent trade and a closing price of that stock at the closing day prior to the most recent trade. Other suitable calculations may be used.

Although embodiments of the invention are not limited in this regard, the term “closing price” or an “opening price” as used herein may include, for example, a price of a stock at a time of day designated to be a “closing time” and/or an “opening time”, respectively. In some embodiments, a virtual closing time and/or a virtual opening time may be set, even if the gaming system allows trading 24 hours per day, 365 days per year.

Although embodiments of the invention are not limited in this regard, the term “real time market data” as used herein may include, for example, information regarding offered prices for buying and selling, bid-prices, ask prices, number of shares offered, closing prices, opening prices, price changes, current prices, trends, market volume, high/low prices over a pre-defined time period, range of stock price in a pre-defined time period, or the like.

Some embodiments may provide an Application Programming Interface (API) or an open API which may be used by third parties or developers or solution providers. Some embodiments may generate output or export information in accordance with one or more pre-defined formats or processes, for example, using XML, using RSS, or the like.

Some embodiments may utilize a “stock value assessment factor”, combining calculation of market activity and movements on various time frames, and real-life performance of the players, and calculated as a quality meter which represents the players. This assessment factor may be used to enforce salary cap for teams in the competition, and as a security measure to identify and prevent frauds attempts of “running” stocks. In some embodiments, the stock value assessment factor may be subject to updating (e.g., between seasons) and/or automatic normalization, as described above.

Although embodiments of the invention are not limited in this regard, the term “initial public offering” or “IPO” as used herein may include, for example, registration or offering of new stocks into the market, such that participants may buy the new stock directly from the issuer, namely, the gaming system administrator. Purchased stocks can then be traded among participants. In some embodiments, secondary or other subsequent public offerings may follow after an IPO, for example, to increase the number of issued shares of a stock that are available for trading.

Although embodiments of the invention are not limited in this regard, the term “bid” as used herein may include, for example, an offer to buy a particular amount of shares of a particular stock at a particular price.

Although embodiments of the invention are not limited in this regard, the term “ask” as used herein may include, for example, an offer to sell a particular amount of shares of a particular stock at a particular price.

Some embodiments may utilize a “Limit Price”, namely, an automated sell order to achieve a specific profit. Some embodiments may utilize a “Stop Loss”, namely, an automated sell order to allow the seller to lose up to a pre-defined amount of money (or percentage of stock price) by triggering a sale if the stock price drops to a target price.

Some embodiments may charge a commission per each successful trade action (Buy or Sell), optionally calculated as a percentage from the price of the trade or at a fixed commission price. Some embodiments may charge an entry fee or a participation fee, in order to register a team for one or more competitions.

In some embodiments, an index may be associated with a group of stocks (for example, a team which includes players), and may gather information based on its components, such as total change or points.

Although embodiments of the invention are not limited in this regard, the term “portfolio” as used herein may include, for example, one or more stocks owned by a user.

Although embodiments of the invention are not limited in this regard, the term “dream team” or “fantasy team” as used herein may include, for example, a collection or assembly of owned shares corresponding to sports players, in accordance with a pre-defined formation requirement, optionally in accordance with other requirements (e.g., salary cap, budget, or the like), and optionally able to be registered for participation in challenges or competitions.

In some embodiments, a competition may be held among team managers for having the dream team with the maximum amount of points in a defined timeframe. Another type of competition may be held among all of the shares holders, for having the most efficient portfolio, calculating the average rate between the real performance and its financial value, and optionally together with calculations of the stocks financial performance. Competitions can be either private or public.

In some embodiments, for example, a fantasy team may include multiple sports player. Each player may accumulate fantasy points, based on a scoring chart or scoring algorithm that takes into account various real-life operations or results of that player and/or of his team. The cumulative sum of fantasy points for all the players of the fantasy team may be regarded as the fantasy score that the fantasy team gained. Out of multiple teams that participated in the challenge, a winning team may be determined based on the challenge rules. For example, in some challenges, the participating fantasy team that accumulated the highest number of fantasy points in the challenge matches may be determined as winner, and the owner of that fantasy team may be entitled to receive a prize.

Although embodiments of the invention are not limited in this regard, the term “league” as used herein may include, for example, a real-life sports league, e.g., the NBA, the NFL, UEFA, Champion's League, or the like.

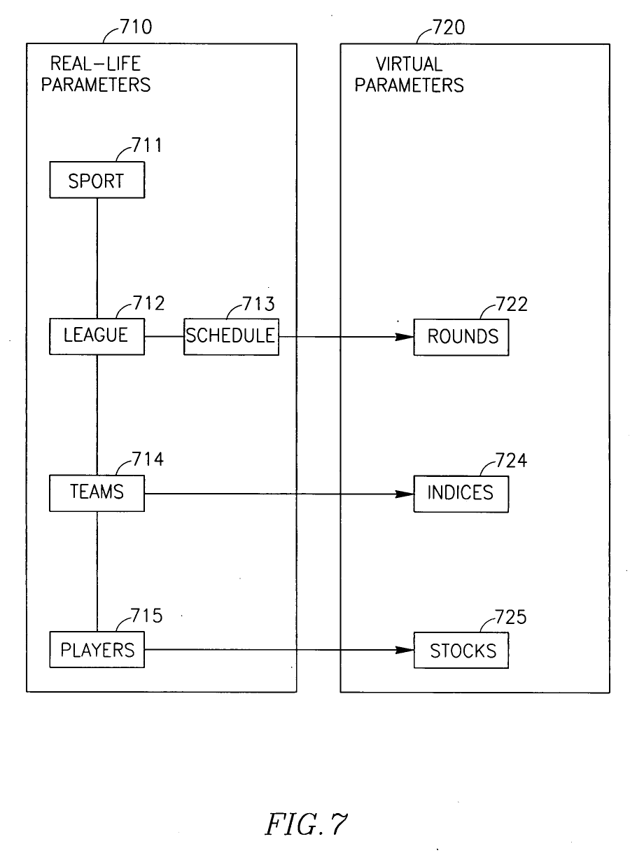

FIG. 7 schematically illustrates conversion between real-life parameters 710 into virtual parameters 720 in accordance with some demonstrative embodiments of the invention. For example, the real-life parameters may be in the field of sports 711. A real-life league 712, optionally associated with a real-life schedule 713 of matches, may correspond to virtual rounds 722. Real-life sports players 715 may correspond to virtual stocks 725. Real-life sports teams 714, where each team is an assembly of real-life players 715, may correspond to virtual indices 724, where each index is an assembly of virtual stocks.

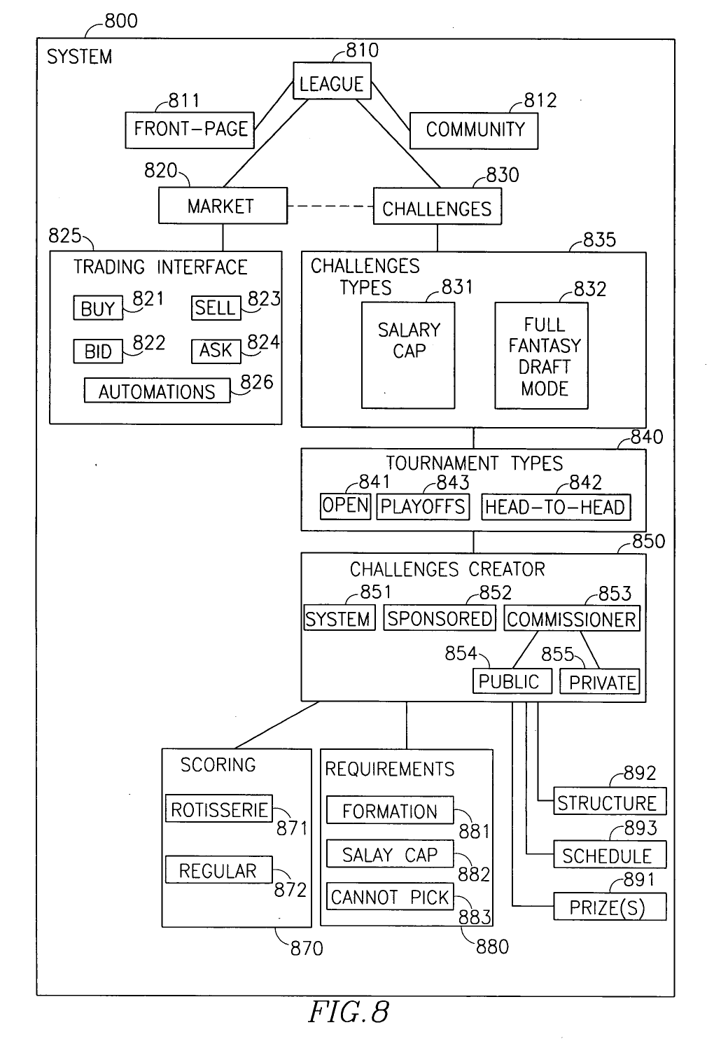

FIG. 8 schematically illustrates a hierarchical organization of a gaming system 800 in accordance with some demonstrative embodiments of the invention. System 800 may include a sports league 810, which may be operable associated with a web-site front-page 811 and a community 812. The league 810 may be operable associated with a market section 820 and a challenges section 830. The market section 820 may include a trading interface 825, for example, a buy mechanism 821 to place “buy” orders, a bid mechanism 822 to place “bid” calls, a sell mechanism 823 to place “sell” orders, an ask mechanism 824 to place “ask” calls, and an automations interface 826.

The challenges section 830 may include one or more challenges types 835, for example, a salary cap requirement 831, a full fantasy draft mode 832, or the like. In addition, one or more tournament types 840 may be used, for example, an open tournament 841 (e.g., each team plays against substantially each other team in the house of the tournament), head-to-head tournament 842 (e.g., the loser from each match is rejected from the tournament, while winners proceed to the next round), “playoffs” 843, or other tournament types 840. The challenges 830 may be associated with challenges creators 850, for example, system's challenges 851 that are set by the administrator of the gaining system 800, sponsored challenges 852, and commissioner's challenges 853 (e.g., public challenges 854 and private challenges 855). Challenges 830 may further be associated with one or more scoring systems (e.g., a rotisserie scoring system 871, a regular scoring system 872, or the like); with one or more requirements 880 (e.g., formation requirements 881, a salary cap 882, a “cannot pick” list 883, or the like); with a structure 892, a schedule 893, and one or more prizes 891.

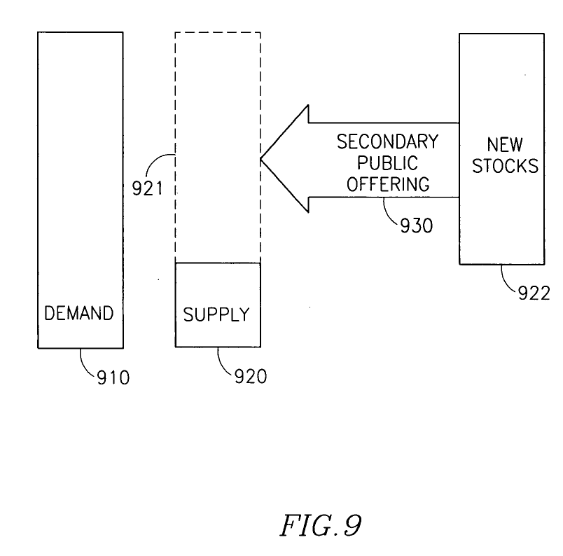

FIG. 9 schematically illustrates market monitoring and expansion in accordance with some demonstrative embodiments of the invention. The gaming system may monitor the supply and the demand for stocks. For example, the gaming system may identify a demand 910 and a supply 920, wherein the supply 920 is significantly smaller than the demand 910 (e.g., smaller by a calculated difference 921). The identification of the significant difference 921 between the supply 920 and the demand 910 of a stock, may trigger—automatically or manually—correction and expansion of the market, for example, by “injecting” into the market additional new shares of the stock being monitored. For example, a new package of stock 922 may be registered in the market, the new package of stock 922 having a number of shares similar to the number of shares of the difference 921. The new package of stock 922 may be injected into the market, for example, using a secondary public offering, as indicated by arrow 930.

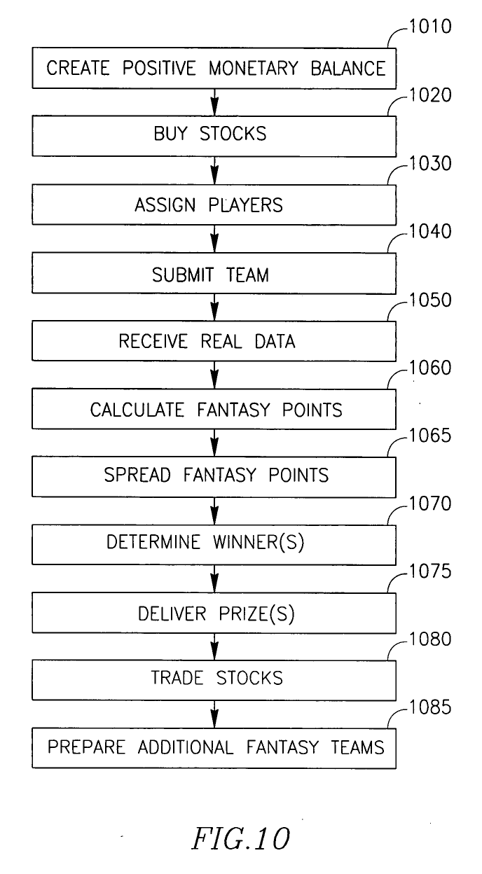

FIG. 10 is a schematic flow-chart of a method of gaming and investing in accordance with some demonstrative embodiments of the invention.

As indicated at block 1010, optionally, a participant may pay an amount of money to the gaming system in order to have a positive monetary balance, so that the participant may be able to purchase stocks corresponding to sports players.

As indicated at block 1020, the participant may buy shares of stocks corresponding to sports players, for example, at a public offering and/or from other participants. The price paid is deducted from the participant's monetary balance, whereas the shares purchased are added to the virtual portfolio of stocks that the participant owns. The purchasing process may include utilization of “ask” and “bid” calls, of “buy” and “sell” orders, of automation mechanisms to automate trading, of expiration parameters to control trading, or the like.

As indicated at block 1030, the participant may assign one or more of the players into a fantasy team. The participant may assign to his fantasy team a player if the participant owns at least one share of stock corresponding to that player. The assignment may be into the actual squad that is intended to play, or to a bench of substitute players. The assignment may optionally be performed in sketch mode, for example, prior to paying participation fees to the gaming system. In some embodiments, the assignment may be in accordance with various requirements or schemes, for example, the assignment may be in accordance with a salary cap, the assignment may be in accordance with a draft mode (e.g., optionally including trading of players among participants), the assignment may be in accordance with formation requirements, or the like.

As indicated at block 1040, the participant may submit his fantasy team to the challenge. The fantasy team may be required to meet pre-defined requirements, for example, formation requirements, a salary cap or budget, or the like.

As indicated at block 1050, the gaming system may receive data (e.g., statistical data) corresponding to real-life performance of sports players (e.g., in XML format, from a data feed, or the like).

As indicated at block 1060, the gaming system may calculate the fantasy points that correspond to the real-life performance.

As indicated at block 1065, the gaming system may spread the fantasy points to the relevant fantasy players.

As indicated at block 1070, the gaming system may determine the winner(s) of the challenge.

As indicated at block 1075, the gaming system may optionally deliver prize(s) to the winner(s) of the challenge. For example, a monetary prize may be provided to the winner, e.g., by paying money to his monetary balance in the gaming system.

As indicated at block 1080, the participant may continue to trade stocks corresponding to sports players.

As indicated at block 1085, the participant may prepare one or more fantasy teams for one or more other challenges.

Other operations or sets of operations may be used in accordance with some embodiments of the invention.

Although portions of the discussion herein may relate, for demonstrative purposes, to an administrator or operator of the gaming system or the stock exchange market as the entity able to perform or to initiate an initial public offering (IPO) or a secondary/subsequent public offering or a registration of new or additional shares of stock corresponding to a sports player, embodiments of the invention are not limited in this regard. In some embodiments, the administrator or operator may be the exclusive issuer or initiator of registration of new or additional shares. In other embodiments, an issuing entity may issue or may initiate registration of new or additional shares, for example, in addition to the administrator or operator, or instead of the administrator or operator. In some embodiments, the issuing entity may be or may include, for example, a “market maker” entity, a trading firm or a trading house, an investment firm or an investment house, an entity similar to a banking entity, a trading channel or distributor, or the like. In other embodiments, the issuing entity may be or may include, for example, one or more users or participants, or a type of users or participants, for example, a “power user” or a “super user” that accumulated significant trading experience, a user that was selected randomly or pseudo-randomly from a group of users that requested to be an issuing entity, a user or participant that paid to the administrator or operator a special fee or commission for issuing or registering new or additional shares of stocks, or the like. In some embodiments, for example, the issuing entity may pay or pre-pay to the administrator or operator an amount of real-life currency (e.g., 500 dollars), and in return may be granted a right to issue a particular number of shares of a stock (e.g., 100 shares of stock corresponding to Player 17), optionally with conditions or criteria set by the administrator or operator (for example, conditions defining the time window in which the new shares may be registered; conditions defining the number of times that the issuing entity may exercise its issuing right, e.g., a total of three public offerings to offer the 100 shares; conditions defining the minimum price per share and/or the maximum price per share, optionally setting a maximum premium that the issuing entity may gain (e.g., a maximum premium of 20 percent), or other conditions). In some embodiments, the administrator or operator may delegate or assign some or all of its issuing or registration capabilities with one or more issuing entities.

Although portions of the discussion herein may relate, for demonstrative purposes, to “shares” of stock or to a “stock” corresponding to a sports player, embodiments of the invention are not limited in this regard. In some embodiments, for example, one or more types of shares of stock corresponding to a particular sports player may be used (or non-stock instruments or securities may be used) for various purposes, for example, ordinary shares, common shares, preferred shares, preference shares, equity or non-equity shares or securities, shares or securities having par value or without par value, and other types of instruments or securities (e.g., cumulative, participating, convertible, or the like). In some embodiments, the stock exchange for trading shares of stock corresponding to sports player may allow creation and/or trading of options (e.g., a Call option, a Put option, or the like). In some embodiments, dividends may be distributed in connection with stocks corresponding to a sports player; for example, the administrator or operator may determine and/or announce that participants that own shares of stock corresponding to Player 32 will receive a dividend of five cents per share on a particular day.

Some embodiments of the invention may be implemented by software, by hardware, or by any combination of software and/or hardware as may be suitable for specific applications or in accordance with specific design requirements. Some embodiments of the invention may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of a specific implementation.

Some embodiments of the invention may be implemented, for example, using a machine-readable medium or article which may store an instruction or a set of instructions that, if executed by a machine, cause the machine to perform a method and/or operations in accordance with embodiments of the invention. Such machine may include, for example, any suitable processing platform, computing platform, computing device, processing device, computing system, processing system, computer, processor, portable or non-portable computing device, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, Flash card or Flash memory, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Visual C++, Java, JavaScript, BASIC, Visual BASIC, Pascal, Fortran, Cobol, PHP, ASP, Dot Net, AJAX, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A system comprising:
a computing platform to register for sale a stock, wherein the stock corresponds to a real-life sports player and wherein the stock is associated with a real-life price.

2. The system of claim 1, wherein the computing platform is operably associated with a database able to store information regarding ownership of shares of said stock.

3. The system of claim 2, wherein the computing platform comprises a trading interface to transfer one or more shares of said stock from a first user of said system to a second user of said system, and to transfer a price of said one or more shares from an account of said first user to an account of said second user.

4. The system of claim 3, wherein the trading interface is to update said database to reflect change of ownership of said one or more shares from said first user to said second user.

5. The system of claim 1, wherein the computing platform is to detect that a market demand for said stock is greater than a market supply of said stock, to determine that a market failure exists, and to register for sale new shares of said stock based on a difference calculated between said market demand and said market supply.

6. The system of claim 1, further comprising:
an assignment interface to selectively assign a first sports player to a first position in a fantasy sports team and a second sports player to a second position in said fantasy sports team.

7. The system of claim 6, wherein the fantasy sports team is associated with a user of said system having a stock portfolio including at least one share of stock corresponding to said first sports player and at least one share of stock corresponding to said second stock player.

8. The system of claim 7, further comprising:
a game engine to receive information of real-life performance of said first sports player, to convert said information into one or more fantasy points, and to add said one or more fantasy points to fantasy scores of one or more fantasy sports teams which include said first sports player.

9. The system of claim 8, wherein the game engine is to determine a winning fantasy sports team out of a plurality of fantasy sports teams based on a comparison of the fantasy scores of said fantasy sports teams.

10. The system of claim 9, wherein said fantasy sports teams virtually compete in a full draft competition in which said first sports player is exclusively assigned to a first fantasy team of said fantasy sports teams, wherein one or more shares corresponding to said first sports player are transferable to a second fantasy team of said fantasy sports teams.

11. The system of claim 9, wherein said fantasy sports teams virtually compete in a competition having a salary cap requiring that a sum of virtual salaries corresponding to sports players of said fantasy sports team be smaller than a maximal value.

12. The system of claim 1, wherein the system is to insert a quote of said real-life price of said stock in a media information item.

13. A method comprising:
registering for sale a stock, wherein the stock corresponds to a real-life sports player and wherein the stock is associated with a real-life price.

14. The method of claim 13, further comprising:
storing information regarding ownership of shares of said stock.

15. The method of claim 14, further comprising:
transferring one or more shares of said stock from a first user to a second user; and
transferring a price of said one or more shares from an account of said first user to an account of said second user.

16. The method of claim 15, comprising:
updating the ownership information to reflect change of ownership of said one or more shares from said first user to said second user.

17. The method of claim 13, further comprising:
detecting that a market demand for said stock is greater than a market supply of said stock;
determining that a market failure exists; and
registering for sale new shares of said stock based on a difference calculated between said market demand and said market supply.

18. The method of claim 13, further comprising:
selectively assigning a first sports player to a first position in a fantasy sports team and a second sports player to a second position in said fantasy sports team.

19. The method of claim 18, wherein the fantasy sports team is associated with a user having a stock portfolio including at least one share of stock corresponding to said first sports player and at least one share of stock corresponding to said second stock player.

20. The method of claim 19, further comprising:
receiving information of real-life performance of said first sports player;
converting said information into one or more fantasy points; and
adding said one or more fantasy points to fantasy scores of one or more fantasy sports teams which include said first sports player.

21. The method of claim 20, further comprising:
determining a winning fantasy sports team out of a plurality of fantasy sports teams based on a comparison of the fantasy scores of said fantasy sports teams.

22. The method of claim 21, wherein said fantasy sports teams virtually compete in a full draft competition in which said first sports player is exclusively assigned to a first fantasy team of said fantasy sports teams, wherein one or more shares corresponding to said first sports player are transferable to a second fantasy team of said fantasy sports teams.

23. The method of claim 21, wherein said fantasy sports teams virtually compete in a competition having a salary cap requiring that a sum of virtual salaries corresponding to sports players of said fantasy sports team be smaller than a maximal value.

24. The method of claim 13, further comprising:
inserting a quote of said real-life price of said stock in a media information item.

25. An apparatus comprising:
a trading interface to transfer one or more shares of a stock, wherein the stock corresponds to a real-life sports player and wherein the stock is associated with a real-life price, from a first user of said apparatus to a second user of another apparatus.

26. The apparatus of claim 25, wherein said trading interface is to indicate that a price of said one or more shares is transferred from an account of said first user to an account of said second user.

27. The apparatus of claim 25, further comprising:
an assignment interface to selectively assign a first sports player to a first position in a fantasy sports team and a second sports player to a second position in said fantasy sports team.

28. The apparatus of claim 27, wherein the fantasy sports team is associated with a user having a stock portfolio including at least one share of stock corresponding to said first sports player and at least one share of stock corresponding to said second stock player.

29. The apparatus of claim 28, wherein the fantasy sports team virtually competes with one or more other fantasy sports teams in a competition based on a comparison of fantasy scores of fantasy sports teams, and wherein the competition comprises a competition selected from a group consisting of:
a full draft competition in which said first sports player is exclusively assigned to a first fantasy team of said fantasy sports teams, wherein one or more shares corresponding to said first sports player are transferable to a second fantasy team of said fantasy sports teams; and
a competition having a salary cap requiring that a sum of virtual salaries corresponding to sports players of said fantasy sports team be smaller than a maximal value.

30. The apparatus of claim 25, wherein said apparatus is to present a quote of said real-life price of said stock embedded in a media information item.
